(19) United States
(12) Patent Application Publication
(10) Pub. No.: US 2024/0085916 A1
(43) Pub. Date: Mar. 14, 2024

(54) SYSTEMS AND METHODS FOR ROBOTIC DETECTION OF ESCALATORS AND MOVING WALKWAYS

(71) Applicant: Brain Corporation, San Diego, CA (US)

(72) Inventors: Eugene Izhikevich, San Diego, CA (US); Ryan Lustig, San Diego, CA (US); Oleg Sinyavskiy, San Diego, CA (US); Jean-Baptiste Passot, San Diego, CA (US)

(21) Appl. No.: 18/379,442

(22) Filed: Oct. 12, 2023

Related U.S. Application Data
(63) Continuation of application No. PCT/US22/24362, filed on Apr. 12, 2022.
(60) Provisional application No. 63/174,701, filed on Apr. 14, 2021.

(51) Int. Cl. G05D 1/02; G01C 21/20; G01S 17/89; G06T 7/246; G06V 10/74; G06V 20/58

(52) U.S. Cl. CPC G05D 1/0214; G01C 21/20; G01S 17/89; G06T 7/246; G06V 10/761; G06V 20/58; G05D 2201/0211

(57) ABSTRACT

Systems and methods for robotic detection of escalators are disclosed herein. According to at least one non-limiting exemplary embodiment, a robot may navigate a learned route and utilize one or more methods of detecting an escalator using data from its sensors. The robot may subsequently avoid the area comprising the escalator.

### PRIORITY

This application in a continuation of International Patent Application No. PCT/US22/24362 filed Apr. 12, 2022 and claims priority to U.S. provisional patent application No. 63/174,701 filed Apr. 14, 2021 under 35 U.S.C. § 119, the entire disclosure of which is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for robotic detection of escalators and moving walkways.

### SUMMARY

The foregoing needs are satisfied by the present disclosure, which provides for, inter alfa, systems and methods for robotic detection of escalators and moving walkways.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally refer to an autonomous vehicle or object that travels a route, executes a task, or otherwise moves automatically upon executing or processing computer-readable instructions.

According to at least one non-limiting exemplary embodiment, a robotic system is disclosed. The robotic system comprises: at least one controller configured to execute computer-readable instructions from a non-transitory computer-readable storage medium to navigate a robot through a route; detect, using data from at least one sensor unit, an escalator; modify the route to cause the robot to stop upon detection of the escalator; and navigate the robot away from the escalator.

According to at least one non-limiting exemplary embodiment, the controller is further configured to execute the instructions to: plot a location of the escalator on a computer-readable map using a no-go zone, wherein the no-go zone includes a region which the robot avoids navigating therein.

According to at least one non-limiting exemplary embodiment, the at least one sensor unit includes units for localizing the robot; and the no-go zone corresponding to the escalator is placed on the computer-readable map by an operator providing an input to a user interface of the robot.

According to at least one non-limiting exemplary embodiment, the route was previously learned by an operator of the robot via the operator driving, pushing, pulling, leading, or otherwise moving the robot through the route.

According to at least one non-limiting exemplary embodiment, the user interface displays the computer-readable map to the operator; and the user input corresponds to the operator defining a region which encompasses the escalator on the computer-readable map during teaching of the route.

According to at least one non-limiting exemplary embodiment, the at least one sensor includes a gyroscope, the data from the gyroscope indicates the robot is vibrating due to navigating over a grated metallic plate near an escalator.

According to at least one non-limiting exemplary embodiment, the robotic system of claim 1, wherein, the at least one sensor includes an image sensor, the data from the image sensor includes a plurality of images; and the at least one controller is further configured to execute the instructions to detect optical flow within the plurality of images, the optical flow being substantially upwards or downwards indicates the presence of moving steps of an escalator.

According to at least one non-limiting exemplary embodiment, the optical flow is detected using a vertical strip of pixels within the plurality of images.

According to at least one non-limiting exemplary embodiment, the at least one sensor includes an image sensor, the data from the image sensor includes a plurality of images; and the at least one controller is further configured to execute the instructions to embody a model, the model is configured to compare the plurality of images with images from a library of escalator images and, upon one or more images of the plurality of images exceeding a threshold similarity with images from the library, cause the controller to detect the escalator.

According to at least one non-limiting exemplary embodiment, the at least one controller is further configured to execute the instructions to: receive a scan from a LiDAR sensor; and provide the depth data to the model, wherein the model is further configured to compare the plurality of images and the depth data from the LiDAR to the library of images and a library of depth data, the library of depth data includes at least in part depth data of one or more escalators; wherein, the model is further configured to detect similarities in contemporaneously captured depth data from the LiDAR sensor and images from the image sensor with pairs of images and depth data of escalators within the library of images and library of depth data.

According to at least one non-limiting exemplary embodiment, the at least one controller is further configured to execute the instructions to: determine if the robotic system is delocalized based at least in part on scan matching; and stop the robot if at least one of an escalator being detected or the robot becoming delocalized.

According to at least one non-limiting exemplary embodiment, a method of navigating a robot is disclosed. The method, comprises a controller of the robot: navigating the robot through a route; detecting, using data from at least one sensor unit, an escalator; and stopping or slowing the robot; and attempting to navigate away from the escalator if the detection is detected, or hailing for human assistance if a collision free path is not available.

According to at least one non-limiting exemplary embodiment, the detecting of the escalator further comprises the controller: detecting, within a LiDAR scan, a standard width ahead of the robot at approximately a height of a floor upon which the robot navigates.

According to at least one non-limiting exemplary embodiment, the standard width comprises approximately 24 inches, 32 inches, 40 inches, or a pre-programmed value corresponding to a width of one or more escalators or moving walkways within an environment of the robot.

According to at least one non-limiting exemplary embodiment, detecting of the escalator further comprises the controller: executing a pre-configured model, the pre-configured model being configured to receive as input one or both of a LiDAR scan and an image captured by either a single depth camera or a LiDAR sensor and an imaging sensor contemporaneously, and receiving as output from the pre-configured model an indication of escalator presence within one or both of the LiDAR scan and the image.

According to at least one non-limiting exemplary embodiment, the pre-configured model is further configured to identify at least one of which points of the LiDAR scan and which pixels of the input image represent the escalator; and transferring the locations of the points or pixels onto a computer-readable map as a no-go zone, the no-go zone comprising a region within which navigation is impermissible by the robot.

According to at least one non-limiting exemplary embodiment, the detecting of the escalator further comprises the controller: capturing a sequence of scans from a LiDAR sensor; detecting a cliff ahead of the robot; stopping the robot in response to the cliff; and detecting the escalator by, while stopped, detecting a region within the sequence of scans from the LiDAR sensor, a region comprising a periodic distance measurement, the region corresponding to moving steps of an escalator.

According to at least one non-limiting exemplary embodiment, the LiDAR sensor is configured to sense an area in a forward direction of travel of the robot, wherein the area is at a distance greater than or equal to the maximum stopping distance of the robot plus a width of an escalator stair step.

According to at least one non-limiting exemplary embodiment, a robot is disclosed. The robot comprises: a non-transitory computer-readable storage medium having a plurality of computer-readable instructions stored thereon; and a controller configured to execute the instructions to: navigate the robot along a route; detect an escalator, the detection of the escalator is performed by one or more of the controller: (i) detecting, within a LiDAR scan, a standard width ahead of the robot at approximately a height of a floor upon which the robot navigates, wherein the standard width comprises approximately 24 inches, 32 inches, 40 inches, or a pre-programmed value corresponding to a width of one or more escalators or moving walkways within an environment of the robot; or (ii) executing a pre-configured model, the pre-configured model being configured to receive as input one or both of a LiDAR scan and an image captured by either a single depth camera or a LiDAR sensor and an imaging sensor contemporaneously, and receiving as output from the pre-configured model an indication of escalator presence within one or both of the LiDAR scan and the image; or (iii) capturing a sequence of scans from a LiDAR sensor, detecting a cliff ahead of the robot, stopping the robot in response to the cliff, and detecting the escalator by, while stopped, detecting a region within the sequence of scans from the LiDAR sensor a region comprising a periodic distance measurement, the region corresponding to moving steps of an escalator; or (iv) detect, via a gyroscope, the robot vibrating via detecting a sudden increase in noise or rapid small rotations from the gyroscope, stopping the robot, and detecting a metallic plate in front of an escalator upon the vibrations ceasing while the robot is idle; and attempting to navigate away from the escalator if the detection is detected, or hailing for human assistance if a collision free path is not available.

According to at least one non-limiting exemplary embodiment, the pre-configured model is further configured to identify at least one of which points of the LiDAR scan and which pixels of the input image represent the escalator; and transferring the locations of the points or pixels onto a computer-readable map as a no-go zone, the no-go zone comprising a region within which navigation is impermissible by the robot.

According to at least one non-limiting exemplary embodiment, the LiDAR sensor is configured to sense an area in a forward direction of travel of the robot, wherein the area is at a distance greater than or equal to the maximum stopping distance of the robot plus a width of an escalator stair step.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIGS. 2A(i-ii) illustrate a light detection and ranging (“LiDAR”) sensor and point cloud data therefrom in accordance with some embodiments of this disclosure.

FIG. 2B illustrates various transformations between a world frame, robot frame, and sensor frames of reference in accordance with some embodiments of this disclosure.

FIG. 3A illustrates two exemplary scenarios of a robot approaching an escalator, according to an exemplary embodiment.

FIGS. 3B-C illustrate a method of detecting an escalator via optical flow, according to an exemplary embodiment.

FIG. 4A(i-ii) and FIG. 4B(i-ii) illustrate a method of detecting an escalator via detecting the apparent appearance and disappearance of a first moving step, according to an exemplary embodiment.

FIG. 5A is a functional block diagram of a system configured to utilize image comparison to detect escalators, according to an exemplary embodiment.

FIG. 5B is a functional block diagram of a system configured to utilize multiple sensor modalities to detect escalators, according to an exemplary embodiment.

FIGS. 6A-C illustrate a method of detecting an escalator via sensing vibrations due to a robot navigating on a grated metallic plate, according to an exemplary embodiment.

FIG. 7 is a process flow diagram illustrating a method of detecting an escalator via sensing vibrations from a gyroscope, according to an exemplary embodiment.

FIGS. 8A-C illustrate a process of scan matching in accordance with some embodiments of this disclosure.

FIGS. 9A-C illustrate how scan matching may be utilized to detect if a robot is delocalized, according to an exemplary embodiment.

FIG. 10 is a table representing the relationship between localization and the various escalator detection methods of this disclosure, according to an exemplary embodiment.

FIG. 11A is a process flow diagram illustrating a method for a user to indicate the location of escalators during training of a robot, according to an exemplary embodiment.

FIGS. 11B(i-ii) illustrate two methods of localizing an escalator based on a robot receiving a user input indicating the presence of an escalator, according to exemplary embodiments.

FIG. 12 is a process flow diagram illustrating a method for a controller to detect an escalator from a LiDAR scan, according to an exemplary embodiment.

FIG. 13 is a process flow diagram illustrating a method for a controller to detect an escalator from a LiDAR scan and/or image, according to an exemplary embodiment.

FIG. 14 is a process flow diagram illustrating a method for a controller to detect an escalator from a sequence of LiDAR scans, according to an exemplary embodiment.

All Figures disclosed herein are © Copyright 2022 Brain Corporation. All rights reserved.

### DETAILED DESCRIPTION

Currently, escalators and moving walkways pose a unique hazard to robots as escalators and moving walkways need to be detected prior to a robot navigating onto a first moving step. Upon moving on top of the moving step or moving walkway, the robot may be carried onto the escalator or walkway which may be hazardous to the robot, escalator, and nearby humans. Some robots are large, e.g., 300 pounds or more, wherein navigating onto an escalator or moving walkway may be incredibly dangerous. Typically, escalators include a standardized width; however, some escalators include glass or transparent walls, making the width difficult to detect for some light-based sensors. Moving walkways are typically flat and may not pose the same risk of damage, however, a robot unknowingly moving onto a moving walkway may become delocalized. Accordingly, there is a need in the art for improved systems and methods for detecting escalators and moving walkways.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for robotic detection of escalators and moving walkways. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAY® vehicles, etc.), trailer movers, vehicles, and the like. Robots may also include any autonomous and/or semi-autonomous machine for transporting items, people, animals, cargo, freight, objects, luggage, and/or anything desirable from one location to another.

As used herein, an escalator may include a series of upward or downward moving steps in a staircase. Although the present disclosure discusses escalators, one skilled in the art may appreciate that horizontal or inclined moving walkways, such as those found in airports, pose a similar hazard to robots. These moving walkways may have properties similar to those of escalators, including hand rails, balustrades, standardized widths, metallic plates, and the like. Accordingly, the systems and methods of this disclosure may also be applicable to horizontal moving walkways, as appreciated by one skilled in the art. For simplicity of presentation, “escalator” as used herein generally includes both moving steps and moving walkways of either pallet or moving belt types, unless specified otherwise.

As used herein, a moving walkway may include a moving conveyor mechanism that transports people and/or items across a horizontal or inclined plane. Typically, moving walkways come in one of two forms: a pallet type comprising a continuous series of flat metal plates joined together to form a walkway and are effectively identical to escalators in their construction, and moving belt types comprising mesh metal belts or rubber walking surfaces which move over/under metallic rollers.

As used herein, a light detection and ranging (“LiDAR”) sensor is comprised of a sensor configured to emit light and measure reflections of the emitted light to detect ranges, or distances. A LiDAR sensor may be comprised of, for instance, 1-dimensional directional LiDAR (e.g., a radar speed gun), 2-dimensional “planar” LiDARs (e.g., spinning beam LiDAR sensors), 3-dimensional LiDARs, or depth cameras. As used herein, a scan from a LiDAR sensor may be comprised of a single measurement from a directional LiDAR, a sweep across a field of view for a planar LiDAR, a scan of a two dimensional field of view of a 3-dimensional LiDAR, or a depth image produced by a single pulse/flash of a depth camera.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic devices (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine-cognizable steps which perform a function. Such computer program and/or software may be rendered in any programming language or environment including, for example, C/C++, C #, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) improve the safety of operating robots in environments with escalators and moving walkways; (ii) improve robotic navigation by enabling robots to avoid hazards in their environment; and (iii) enable robots to operate in more complex and hazardous environments safely. Other advantages are readily discernible by one having ordinary skill in the art, given the contents of the present disclosure.

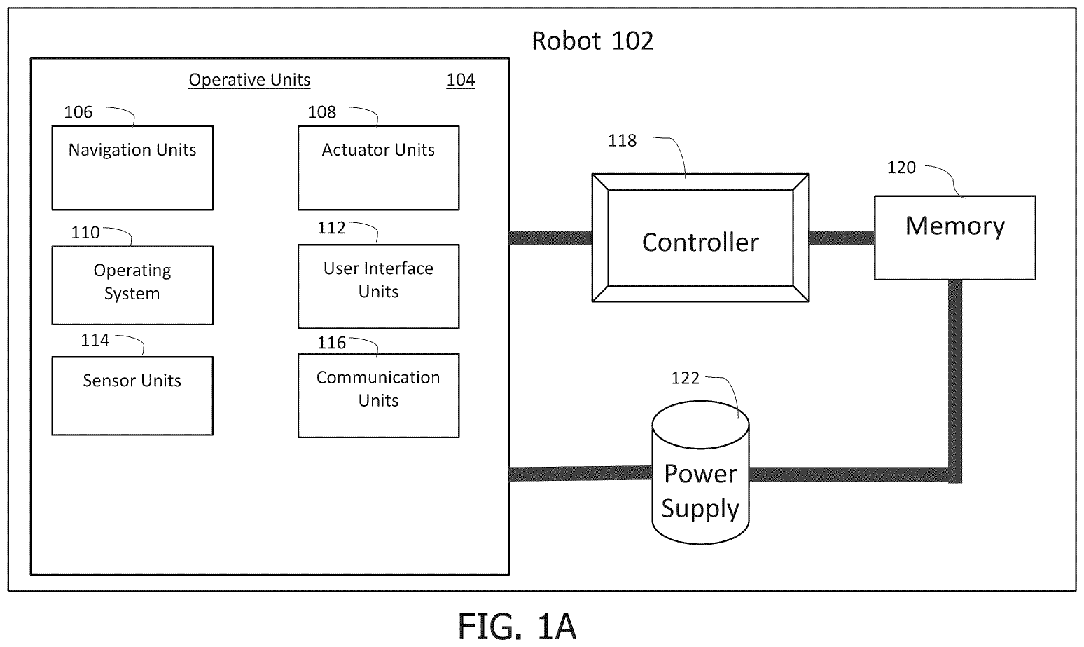

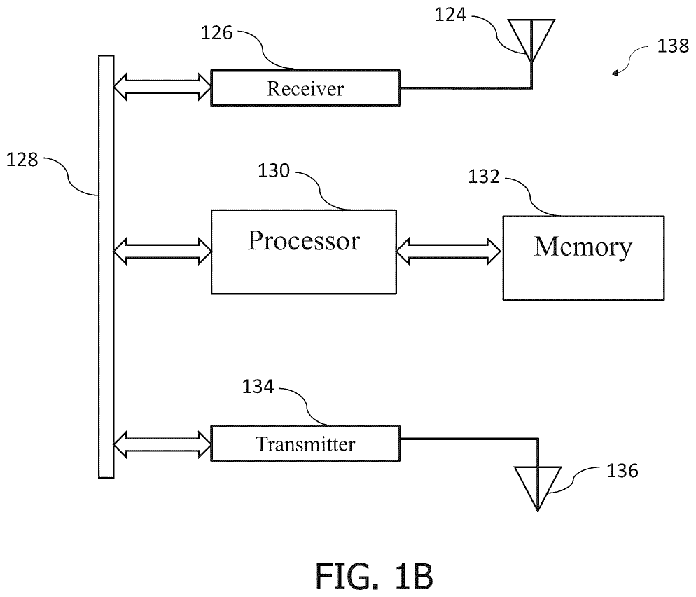

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator units 108, and communications unit 116, as well as other components and subcomponents (e.g., some of which may not be illustrated). Although a specific embodiment is illustrated in FIG. 1A, it is appreciated that the architecture may be varied in certain embodiments, as would be readily apparent to one of ordinary skill given the contents of the present disclosure. As used herein, robot 102 may be representative, at least in part, of any robot described in this disclosure.

Controller 118 may control the various operations performed by robot 102. Controller 118 may include and/or comprise one or more processing devices (e.g., microprocessors) and other peripherals. As previously mentioned and used herein, processor, microprocessor, and/or digital processor may include any type of digital processing device such as, without limitation, digital signal processors (“DSPs”), reduced instruction set computers (“RISC”), complex instruction set computers (“CISC”), microprocessors, gate arrays (e.g., field programmable gate arrays (“FPGAs”)), programmable logic device (“PLDs”), reconfigurable computer fabrics (“RCFs”), array processors, secure microprocessors and application-specific integrated circuits (“ASICs”). Peripherals may include hardware accelerators configured to perform a specific function using hardware elements such as, without limitation, encryption/description hardware, algebraic processors (e.g., tensor processing units, quadratic problem solvers, multipliers, etc.), data compressors, encoders, arithmetic logic units (“ALU”), and the like. Such digital processors may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be internal to or on board of robot 102 and/or may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated, at least in part, with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend, at least in part, on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120 physically incorporated in the robot. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors. In some embodiments, a single controller (e.g., controller 118) may serve as the various controllers and/or processors described. In other embodiments, different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 include at least navigation units 106, actuator units 108, user interface units 112, sensor units 114, and communication units 116. Operative units 104 may also comprise other units, such as specifically configured task units (not shown), that provide the various functionality of robot 102. In exemplary embodiments, operative units 104 may be instantiated in software, hardware, or both software and hardware. For example, in some cases, units of operative units 104 may comprise computer-implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find its position) in a map, and navigate robot 102 to/from destinations. The mapping may be performed by imposing data obtained in part by sensor units 114 into a computer-readable map representative, at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators, such as motors/engines (e.g., electric motors, combustion engines, steam engines, and/or any type of motor/engine known in the art), driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; and/or repose cameras and sensors. According to exemplary embodiments, actuator unit 108 may include systems that allow movement of robot 102, such as motorized propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based, at least in part, on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose, as used herein) relative to the initial location. Such data may be stored in data structures, such as matrices, arrays, queues, lists, stacks, bags, etc. According to exemplary embodiments, the data structure of the sensor data may be called an image.

According to exemplary embodiments, sensor units 114 may be in part external to the robot 102 and coupled to communications units 116 for communication with the controller of the robot. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example, without limitation, a pressure or motion sensor may be disposed at a luggage cart storage location of airport, wherein the controller 118 of the robot 102 may utilize data from the pressure or motion sensor to determine if the robot 102 should retrieve more luggage carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102, but, may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processor, or robot performing a task, operation or transformation illustrated in the figures below comprises a controller executing computer-readable instructions stored on a non-transitory computer-readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processor 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer-readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

One of ordinary skill in the art would appreciate that the architecture illustrated in FIG. 1B may also illustrate an external server architecture configurable to effectuate control of a robotic apparatus from a remote location, such as a remote server. That is, the remote server may also include a data bus, a receiver, a transmitter, a processor, and a memory that stores specialized computer-readable instructions thereon.

One of ordinary skill in the art would appreciate that a controller 118 of a robot 102 may include one or more processors 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices, when instantiated in hardware, are commonly used within the art to accelerate specific tasks (e.g., multiplication, encryption, etc.), which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer-readable instructions to perform a function may include one or more processors 138 thereof executing computer-readable instructions and, in some instances, the use of any hardware peripherals known within the art. Controller 118 may be illustrative of various processors 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processors 138 for performing high-level tasks (e.g., planning a route to avoid obstacles) and processors 138 for performing low-level tasks (e.g., producing actuator signals in accordance with the route).

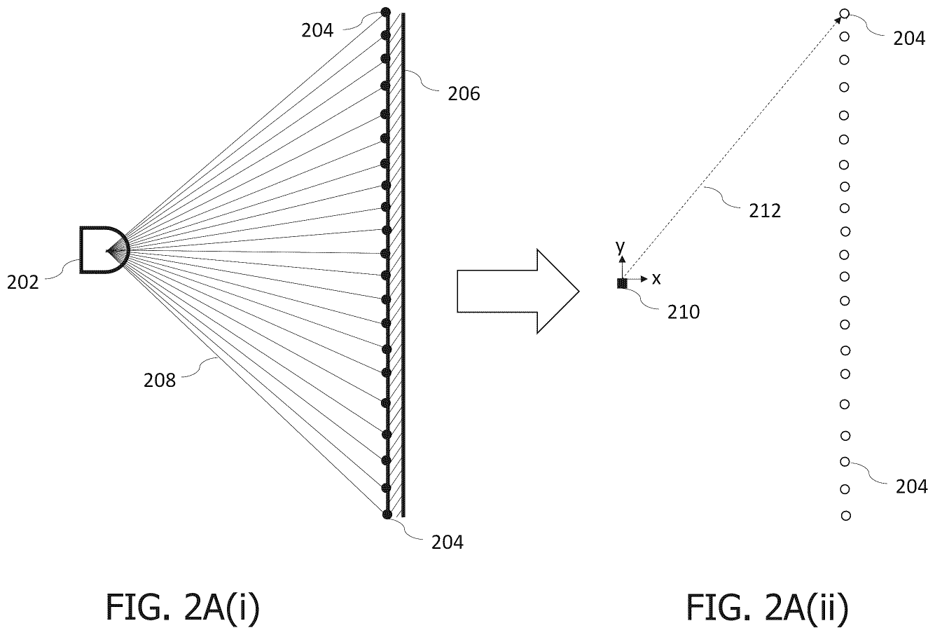

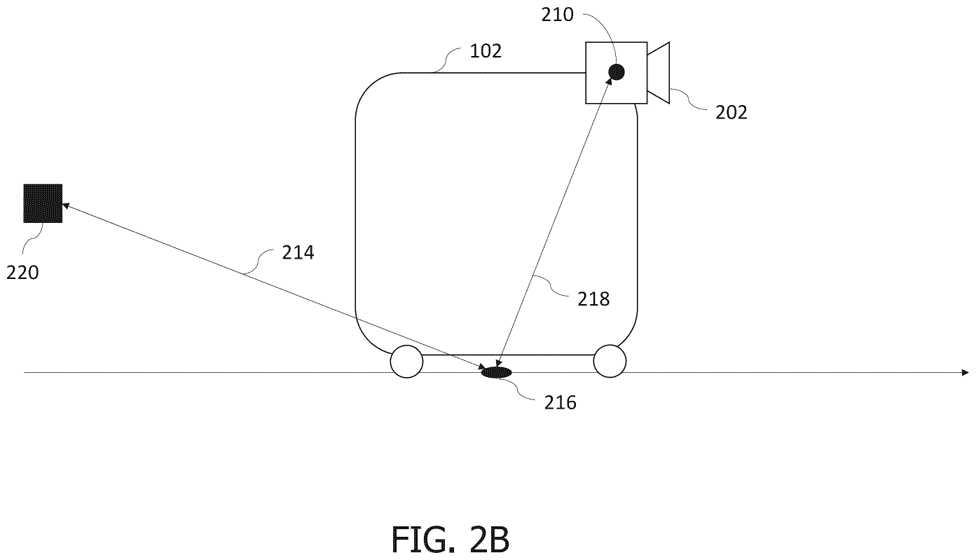

FIG. 2A(i-ii) illustrates a planar light detection and ranging (“LiDAR”) sensor 202 coupled to a robot 102, which collects distance measurements to a wall 206 along a measurement plane in accordance with some exemplary embodiments of the present disclosure. Planar LiDAR sensor 202, illustrated in FIG. 2A(i), may be configured to collect distance measurements to the wall 206 by projecting a plurality of beams 208 of photons at discrete angles along a measurement plane and determining the distance to the wall 206 based on a time of flight (“ToF”) of the photons leaving the LiDAR sensor 202, reflecting off the wall 206, and returning back to the LiDAR sensor 202. The measurement plane of the planar LiDAR 202 comprises a plane along which the beams 208 are emitted which, for this exemplary embodiment illustrated, is the plane of the page.

Individual beams 208 of photons may localize respective points 204 of the wall 206 in a point cloud, the point cloud comprising a plurality of points 204 localized in 2D or 3D space as illustrated in FIG. 2(u). The points 204 may be defined about a local origin 328 of the sensor 202. Distance 212 to a point 204 may comprise half the time of flight of a photon of a respective beam 208 used to measure the point 204 multiplied by the speed of light, wherein coordinate values (x, y) of each respective point 204 depends both on distance 212 and an angle at which the respective beam 208 was emitted from the sensor 202. The local origin 328 may comprise a predefined point of the sensor 202 to which all distance measurements are referenced (e.g., location of a detector within the sensor 202, focal point of a lens of sensor 202, etc.). For example, a 5-meter distance measurement to an object corresponds to 5 meters from the local origin 328 to the object.

Although FIG. 2 illustrates a LiDAR sensor detecting a wall or vertical surface, the same procedure can be used to detect a horizontal surface such as a floor, or any other object(s) having a surface that can reflect LiDAR beams.

According to at least one non-limiting exemplary embodiment, sensor 202 may be illustrative of a depth camera or other ToF sensor configurable to measure distance, wherein the sensor 202 being a planar LiDAR sensor is not intended to be limiting. Depth cameras may operate similar to planar LiDAR sensors (i.e., measure distance based on a ToF of beams 208); however, depth cameras may emit beams 208 using a single pulse or flash of electromagnetic energy, rather than sweeping a laser beam across a field of view. Depth cameras may additionally comprise a two-dimensional field of view rather than a one-dimensional, planar field of view.

According to at least one non-limiting exemplary embodiment, sensor 202 may be illustrative of a structured light LiDAR sensor configurable to sense distance and shape of an object by projecting a structured pattern onto the object and observing deformations of the reflected pattern. For example, the size of the projected pattern may represent distance to the object and distortions in the pattern may provide information of the shape of the surface of the object. Structured light sensors may emit beams 208 along a plane as illustrated or in a predetermined two dimensional pattern (e.g., a circle or series of separated parallel lines).

FIG. 2B illustrates a robot 102 comprising an origin 216 defined based on a transformation 214 from a world origin 220, according to an exemplary embodiment. World origin 220 may comprise a fixed or stationary point in an environment of the robot 102 which defines a (0,0,0) point for the robot 102 within the environment. Origin 216 of the robot 102 may define a location of the robot 102 within its environment. For example, if the robot 102 is at a location (x=5 m, y=5 m, z=0 m), then origin 216 is at a location (5, 5, 0) m with respect to the world origin 220. The origin 216 may be positioned anywhere inside or outside the robot 102 body such as, for example, between two wheels of the robot at z=0 (i.e., on the floor). When discussing the location or position of the robot 102 within its environment or on a computer-readable map herein, it is appreciated that the location or position may refer to the location or position of the origin 216. The transform 214 may represent a matrix of values which configures a change in coordinates from being centered about the world origin 220 to the origin 216 of the robot 102. The value(s) of transform 214 may be based on a current position of the robot 102 and may change over time as the robot 102 moves, wherein the current position may be determined via navigation units 106 and/or using data from sensor units 114 of the robot 102.

The robot 102 may include one or more exteroceptive sensors 202 of sensor units 114, one sensor 202 being illustrated, wherein each sensor 202, including those not illustrated for clarity, includes an origin 328 defined by transform 218. The positions of the sensor 202 may be fixed onto the robot 102 such that its origin 328 does not move with respect to the robot origin 216 as the robot 102 moves. Measurements from the sensor 202 may include, for example, distance measurements, wherein the distances measured correspond to a distance from the origin 328 of the sensor 202 to one or more objects. Transform 218 may define a coordinate shift from being centered about an origin 328 of the sensor 202 to the origin 216 of the robot 102, or vice versa. Transform 218 may be a fixed value, provided the sensor 202 does not change its position. In some embodiments, sensor 202 may be coupled to one or more actuator units 108 configured to change the position of the sensor 202 on the robot 102 body, wherein the transform 218 may further depend on the current pose of the sensor 202 tracked by controller 118 using, e.g., feedback signals from the actuator units 108. It is appreciated that all origins 328, 216, and 220 are points comprising no area, volume, or spatial dimensions and are defined only as a location.

Controller 118 of the robot 102 may always localize the robot origin 216 with respect to the world origin 220 during navigation, using transform 214 based on the robot 102 motions and position in the environment, and, thereby, localize sensor origin 328 with respect to the robot origin 216, using a fixed transform 218, and world origin 220, using transforms 214 and 218. In doing so, the controller 118 may convert locations of points 204 defined with respect to sensor origin 328 to locations defined about either the robot origin 216 or world origin 220. For example, transforms 214, 218 may enable the controller 118 of the robot 102 to translate a 5-m distance measured by the sensor 202 (defined as a 5-m distance between the point 204 and origin 328) into a location of the point 204 with respect to the robot origin 216 (e.g., distance of the point 204 to the robot 102) or world origin 220 (e.g., location of the point 204 in the environment).

It is appreciated that the position of the sensor 202 on the robot 102 is not intended to be limiting. Rather, sensor 202 may be positioned anywhere on the robot 102 and transform 218 may denote a coordinate transformation from being centered about the robot origin 216 to the sensor origin 328, wherever the sensor origin 328 may be. Further, robot 102 may include two or more sensors 202 in some embodiments, wherein there may be two or more respective transforms 218 which each denote the respective locations of the origins 328 of the two or more sensors 202. Similarly, the relative position of the robot 102 and world origin 220, as illustrated, is not intended to be limiting.

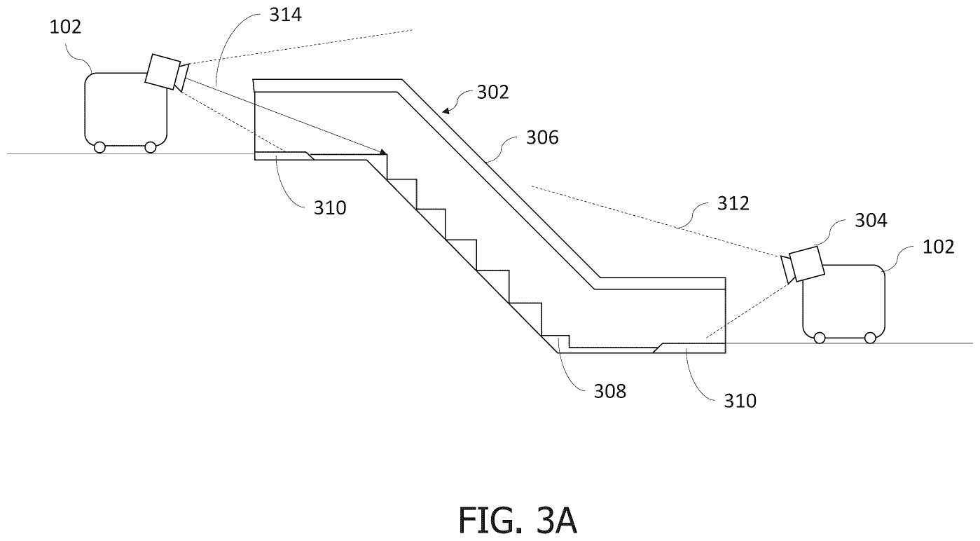

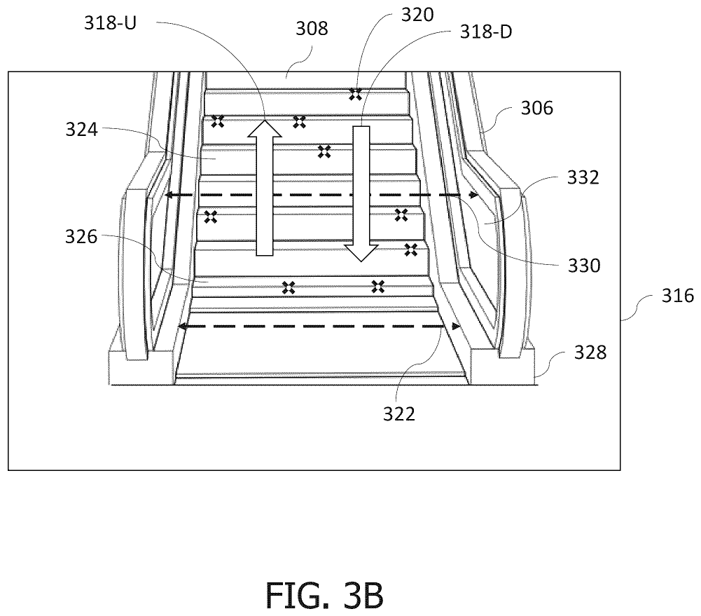

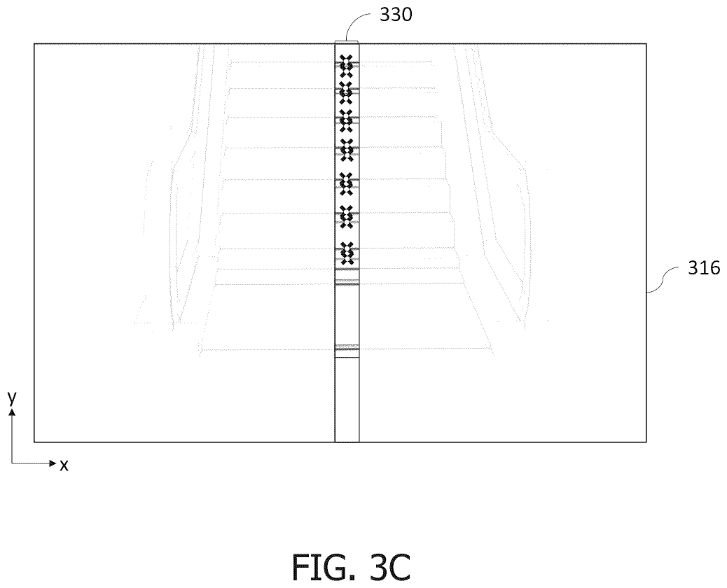

FIG. 3A illustrates two robots 102 at a top and bottom of an escalator 302, according to an exemplary embodiment. One skilled in the art may appreciate that the term escalator may correspond to escalators in the traditional sense as generally present in airports, office buildings, subways or train stations, malls and commercial retail spaces, wherein the stairs are in motion in an upward or downward direction. Alternatively, one skilled in the art may also appreciate that the term escalator may also correspond to a staircase where the stairs are not in motion, but stationary. The two robots 102 may represent the two positions a robot 102 may encounter an escalator 302: while the robot 102 is at the top (left) or at the bottom (right) of the steps 308. In both scenarios, one or more sensors 304 may detect a stationary portion 310 from which moving steps 308 of the escalator 302 emerge from or move under as shown by field of view lines 312 encompassing the stationary portion 310. Sensor 304 may include, but is not limited to, one or more RGB cameras, greyscale cameras, LiDAR sensors 202, depth cameras, and/or any other exteroceptive sensor of sensor units 114. The one or more sensors 304 may further detect at least a portion of the moving steps 308 of the escalator 302. One skilled in the art will appreciate that moving steps 308 correspond to steps in motion relative to a stationary portion 310 as the moving steps 308 move either away or towards (i.e., from under or underneath) the stationary portion 310. Arrow 314 is shown to illustrate how a robot 102 at the top of the escalator 302 is still able to detect at least a portion of the moving steps 308 near the top of the escalator 302 staircase. Additionally, handrails 306 may also be sensed or detected by the one or more sensors 304. In some instances, the side walls of the escalator 302 may be sensed; however, these side walls may include glass or transparent materials invisible to light-based sensors. Thus, in some instances, only side balustrades, skirts, handrails, and/or the base of the side walls of the escalator 302 may be detected.

FIG. 3B illustrates an image 316 of the escalator 302 previously shown in FIG. 3A captured by the one or more sensors 304 while the robot 102 is at the bottom of the escalator 302, wherein the sensor 304 includes a camera comprising a two-dimensional field of view, according to an exemplary embodiment. Image 316 may comprise a greyscale, colorized (e.g., RGB), or depth image. Depth images comprise of two dimensional images wherein, for each pixel, a color value (e.g., greyscale or RGB) and a distance value corresponding to the distance between the sensor which captures the image and a point in the environment depicted by the pixel. More specifically, each pixel of depth imagery is encoded with a distance corresponding to the distance between the sensor 304 origin 210 and an object represented by the pixels within the field of view.

Using the image 316, two methods disclosed herein may be utilized to detect an escalator. The first method comprises of the robot 102 detecting a width 322 of an entranceway (e.g., using a LiDAR or depth camera sensor). The controller 118 may compare the width 322 with standard widths of escalators and, if the width 322 matches with a width of a standard escalator, the controller 118 may assume the entranceway is an entrance to an escalator. Typically, the standardized widths of the steps 308 are approximately 24 inches, 32 inches, or 40 inches (61 cm, 82 cm, and 102 cm respectively) in line with safety standards (e.g., American Society of Mechanical Engineers (“ASME”) ASME A17.1-2007 or Canadian Standards Association (“CSA”) standard CSA B44-07), however, one skilled in the art may appreciate that a robot 102 may be able to recognize any pre-programmed standardized width of an escalator, which may be specific to its environment, as escalator widths are a static parameter. Accordingly, as used hereinafter, a “standard width” of an escalator or moving walkway may include moving steps 308 comprising a width 322 of standard, fixed length determined by either standards/safety associations or the widths of escalators unique to an environment which do not change.

Standard widths of escalators may be saved in the memory 120 of the robot in a pre-configuration or testing phase prior to it being deployed in an environment. If an environment includes escalators which do not comprise 24-, 32-, or 40-inch widths the robot 102 may, in some embodiments, be programmed to receive an input to denote the widths of moving walkways and escalators unique to its environment via its user interface units 112.

Ideally width 322 may be measured between the two balustrades 328, as this provides the most accurate method of measuring step 308 width. For instance, if image 316 is a depth image, width 322 as measured between balustrades 328 provides the most direct measurement of step 308 width as the sides of the steps 308 are in (near) contact with the balustrades 328. However, without prior knowledge that the image 316 contains an escalator, detecting balustrades 328 poses a similar problem as detecting the escalator 302 as a whole. For instance, the depth image 316 also contains a width 330 which is slightly larger than the width 322, wherein it may be difficult to discern which corresponds to the balustrade 328. Further, the sidewalls 332 which support handrails 306 may be glass, and, therefore, transparent to most LiDAR sensors. Accordingly, in some exemplary non-limiting embodiments, a robot 102 may be aware of a potential escalator 302 being present in the depth image 316 if a width 322 that matches a standard width is detected as well as a width 330 that is slightly larger (e.g., ±5 inches or other pre-programmed amount). Width 322 should be near the floor (i.e., z=0 plane) which would be defined via the various transforms 214, 218 shown in FIG. 2B above regardless of if the robot 102 is at the top or bottom of the escalator 302. However, due to these aforementioned limitations and ambiguities, detecting a width of a corridor as matching a standard width of an escalator alone may not always yield accurate escalator detection results and should be used in conjunction with other methods disclosed herein. For instance, detection of a standard width may initiate a robot 102 to perform more computationally taxing analysis disclosed herein of sensor data to confirm a corridor of standard width is an escalator and not simply a hallway or space between two non-escalator objects. In some embodiments, the robot 102 may stop or slow until the corridor is confirmed or disproven to be an escalator as a safety measure.

Another method for detecting or confirming a corridor of standard width is an escalator comprises of the use of optical flow or motion tracking to detect the movement of steps 308. Steps 308 may move upwards or downwards, as shown by arrows 318-U, 318-D, respectively, representing the motion of the steps 308. In some embodiments, a controller 118 may execute computer-readable instructions to perform edge detection, salient point/color analysis detection, or contour detection to detect moving portions of the scene. The images of the steps 308 acquired or obtained by the sensor 304 may comprise salient points 320. Salient points 320 comprise various points within the image determined to be salient (e.g., an edge of the steps 308) using, for example, color, contour or motion analysis. Salient points 320 comprise of pixels that correspond to physical points on the objects within the visual scene, wherein salient points 320 attempt to follow the same physical points over time as new images 316 are acquired.

To illustrate color saliency, controller 118 may detect the edges of the steps 308 or points 320 based on color values of the image 316, wherein the vertical portions 324 of steps 308 may comprise a different color than the horizontal portions 326, thus making the edges of the steps 308 color salient. The difference in color may be caused by, for example, lighting conditions in the environment illuminating the vertical portions 324 of the steps 308 and horizontal portions 326 of the steps 308 differently. By way of illustration, the horizontal portions 326 may be well-illuminated by a light source above the escalator, while the vertical portions 324 are less illuminated (i.e., darker), thereby enabling the controller 118 to identify the horizontal 326 and vertical portions 324 based on the change in color. In addition to color saliency, motion analysis using multiple images 316 may indicate moving elements, the moving elements may be considered as more salient than surrounding stationary elements. One skilled in the art may appreciate the image 316 represented in FIG. 3B is an illustrative example embodiment, wherein the sensor 304 is configured to capture a plurality of such images in real-time and in a continuous manner and the chosen salient points 320 illustrated are not intended to be limiting.

In some embodiments, controller 118 may analyze a plurality of images 316 to detect the points 320 moving upwards or downwards. As discussed above, for safety, the robot 102 should stop or slow down in order to acquire such video stream while avoiding navigating onto a potential moving walkway or escalator. Points 320 may be selected based on the various saliency parameters discussed above of the image, wherein points 320 may correspond to edges of the steps 308 or other salient portion of the steps 308 (e.g., colored markings). By detecting the upward/downward motion of these points 320 in subsequent images 316, the controller 118 may determine that an escalator is present in the image 316 and, in-turn, determine that the escalator 302 is in motion.

In some embodiments, image 316 may be a depth image from a depth camera encoded with distance information. The distance information (e.g., a point cloud) may include an approximately step-like pattern in the center of the image. Points 320 may be selected based on the detection of an edge or corner in the step-like pattern (i.e., instead of or in addition to the use of color saliency). For example, FIG. 3C shows a vertical slice 330 of the depth image 316, according to an exemplary embodiment. By analyzing the derivative of the depth measurements D with respect to the y-axis (vertical) of the image for any vertical strip 330 of pixels within width 322, edges of the steps may be detected when the derivative includes a large spike. To illustrate, dD/dy is small for the vertical portions 324 of the steps 308 (i.e., little change in depth for any dy) while the horizontal portions 326 of the steps 308 may include larger derivatives (i.e., larger change in depth for any dy). Controller 118 may analyze the depth values for the strip 330 of pixels to detect edges of the steps 308, wherein the edges may include any point where the vertical and horizontal portions 326 of the steps 308 meet as shown by the points 320, which may be tracked for motion analysis. Tracking the points 320 through multiple image frames 316 using motion analysis may enable the controller 118 to differentiate a staircase from an escalator. As stated above, it may be critical that the robot 102 detects escalators 302 sufficiently early as to avoid navigating onto a first moving step of the escalator 302 which may pull the robot 102 over or onto the escalator, resulting in harm or damage to the robot 102, nearby humans and the escalator 302 itself. Staircases may be detected at substantially closer ranges since the robot 102 may navigate closer thereto, without such risk of being pulled onto and over the stationary staircase. Stated differently, typical cliff and wall detection and avoidance methods should be sufficient to avoid staircases, but not escalators, due to their movement. However, a skilled artisan would appreciate that a turned-off escalator 302 that does not have the steps in motion, or traveling in upward or downward direction, would be considered a pseudo-staircase as it poses no added risk of damage than a normal, stationary staircase. A moving escalator poses a larger threat of damage than a stationary escalator or staircase as the robot 102 may be carried by the moving steps onto the escalator, wherein moving escalators may be differentiated from stationary ones or staircases by sensing motion (e.g., upward or downward) of salient points 320 between multiple images 316. If motion is detected, the robot 102 may turn away from the escalator 302 at a farther distance than a stationary escalator 302 or staircase.

As an illustrative example, a robot 102 may acquire a depth image as it navigates through its environment. The depth image may contain a distance 322 of 32-inches, a standard step width, between a plurality of points 204 located at approximately z=[0, 4] inches above the floor. Accordingly, since 32 inches is a standard width, the robot 102 should stop or slow down as a potential escalator may be present. As the robot 102 stops or slows, the sensors continue to acquire new depth images thereby enabling motion analysis to occur. From the motion analysis, if movement is detected, the robot 102 may determine an escalator is present and re-route away from the hazard. If no movement is detected, the corridor may comprise of a staircase, idle escalator or two objects separated by 32 inches, wherein typical cliff/wall avoidance methods may be used. These typical cliff/wall avoidance methods may enable the robot 102 to navigate up to the edge of the cliff if so desired as there is no risk the floor near the edge of said cliff may pull the robot 102 over the edge. Advantageously, use of motion analysis in conjunction with standardized width detection removes many false positive escalator detections from using the standardized with detection method alone.

Although detection of the edges of the steps 308 are discussed, in some embodiments, escalators 302 may include painted strips, or similar markings, at the edges of each step 308, typically yellow, or equivalent color thereof such as green, red, orange, etc., that is easy to detect for, e.g., visually impaired humans. These painted strips, if present, may also aid the color saliency detection and may be utilized to generate points 320 for motion tracking.

The methods disclosed in FIG. 3A-C may require the robot 102 to include a forward-facing (relative to the hazards, e.g., escalator entrances) image camera or depth camera, or multiple sensors comprising a field of view encompassing a region ahead of the direction of travel of the robot 102. Though escalators may be detected on the sides or behind a robot 102 using sensors directed towards the sides or rear, escalators ahead of the robot 102 pose the largest risk. However, not all robots 102 include forward facing imaging sensors. Some robots 102 may include one or more sensors configured to sense cliffs (vertical drops), ramps, walls (vertical rises), or other substantial rises or depressions in a floor surrounding the robots 102. These sensors are often positioned at a height above the floor and angled such that the sensor detects the floor at approximately the stopping distance of the robot 102, enabling the robot 102 to stop if a cliff is detected.

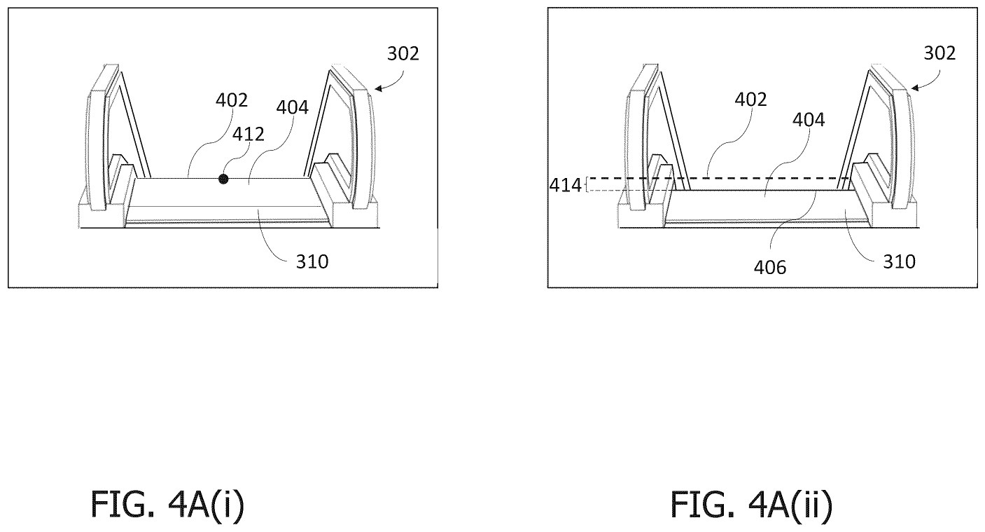

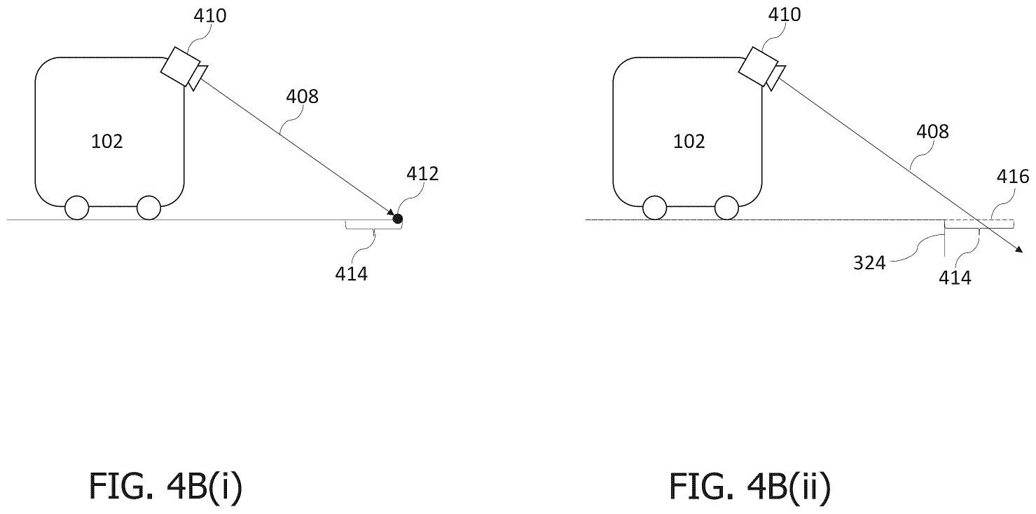

In some embodiments, a planar LiDAR sensor may be positioned in a forward-facing position on the robot 102 at a height above the floor and angled downward such that the LiDAR sensor generates distance measurements between the LiDAR sensor and the floor ahead of the robot 102 along its direction of travel (e.g., sensor 304 of FIG. 3A). An exemplary cliff detection sensor 410 is depicted in FIG. 4B(i-ii) and discussed below. If a cliff is present, the LiDAR sensor may measure a sudden increase in distance measurements (or decrease in the case of walls). Other sensors may be utilized in a similar manner, such as depth cameras, to detect cliffs ahead of the robot 102; however, the following discussion will be directed towards sensors with limited information. For example, one skilled in the art may appreciate that a forward-facing depth camera may detect cliffs and depict potential escalators ahead of the robot 102, whereas a planar LiDAR or directional LiDAR only senses the floor to provide enough stopping distance for the robot 102 if a hazard, e.g., a cliff, is detected. These sensors may also be utilized by a controller 118 to sense escalators.

FIGS. 4A(i-ii) illustrate an escalator as viewed from the top at two different times, according to an exemplary embodiment. When viewed from the top of the escalator 302 configured to move downward, the first step 404 of the escalator emerges, sinks/falls out of view, and the cycle repeats when the next first moving step 404 emerges. Alternatively, for an escalator 302 configured to move upward, the first moving step 404 may subduct beneath a stationary walkway, followed by a next moving step appearing and subducting. When viewed from the top, the first step 404 reaches a maximum distance 402 as shown in FIG. 4A(i) and, subsequently, falls out of view as shown in FIG. 4A(ii). The two images shown may represent an upward or downward moving escalator 302. A dashed line representing the maximum distance 402 is shown in FIG. 4A(ii) to illustrate how the first step 402 appears from beneath a stationary portion 310 (shown from another angle in FIG. 3A above), moves to line 402, and, subsequently, moves downward until out of view, or vice versa. Line or edge 406 may denote the minimum distance of a corner of the first moving step 406 upon the preceding first moving step descending beyond view. The corner corresponding to the points where vertical portions 324 and horizontal portions 326 of the step meet as discussed above with respect to FIG. 3B. The point 412 and distance 414 is illustrated for reference to FIG. 4B(i-ii) discussed next.

FIGS. 4B(i-ii) illustrate a robot 102 approaching the top portion of an escalator 302 from the top of the escalator 302, according to an exemplary embodiment. The robot 102 may be navigating forwards in the direction of the field of view of sensor 410 (i.e., left to right on the page). The various features of the escalator 302, e.g., the balustrades 202, handrails, walls, lip between the stationary plate and the moving step, etc., have been intentionally omitted from the drawing for clarity and to illustrate how a robot 102, using limited information from the sensor 410, may be able to detect an escalator 302. Further, limited data from sensor 410 may not be able to discern the difference between a stationary portion 310 and moving portions (i.e., steps 308) without motion analysis. Sensor 410 may comprise a LiDAR sensor or depth camera configured to measure distances. Specifically, sensor 410 is configured to, at least in part, sense a distance between the sensor 410 and a floor ahead of the robot 102, wherein the sensor 410 measuring a distance other than the distance 408 of FIG. 4B(i) may correspond to a cliff or wall being present ahead of the robot 102, as shown in FIG. 4B(ii) wherein the sensor 410 detects a cliff. The point 412 at which the vector 408 contacts the floor may be equal to or larger than to the maximum stopping distance required by the robot 102 to come to a full stop. Vector 408 may denote the path traveled by a beam emitted from the LiDAR sensor or depth camera sensor 410 (similar to beams 206 shown in FIG. 2A-B). For reasons discussed later, the cliff detection sensor 410 should be capable of detecting cliffs beyond the maximum stopping distance of the robot 102.

As discussed regarding FIG. 4A(i-ii) above, point 412 may correspond to a point 204 on a first moving step 404 of an escalator, a first stationary step of a staircase, or an edge of a cliff. For simplicity, staircases and cliffs will both be considered as stationary cliffs/drop-offs. If an escalator 302 is present, the point 412 may be anywhere between at the maximum distance 402 from which the first moving step 404 extends (FIG. 4A(i)) to the minimum distance 404 when the first moving step 402 has descended beyond view (FIG. 4A(ii)), thereby causing a portion 414 of the floor to appear and disappear as the first moving step 402 appears and descends, assuming a stationary robot 102.

By way of illustrative example, a robot 102 may approach a corridor of standard width and stop as a safety precaution discussed above, as shown in FIG. 4B(i). If the robot 102 moves incrementally forward or if sensor 410 is a depth camera, a cliff will be detected and the robot 102 should stop. Next, in FIG. 4B(ii) the robot 102 detects a cliff based on the distance measurement shown by vector 408 being substantially large, according to an exemplary embodiment. Upon the sensor 410 generating another distance measurement, the distance measurement collected by vector 408 may suddenly increase (as shown by a lack of floor to the right of point 412) despite the robot 102 being idle, thereby indicating presence of a cliff or escalator, whether in motion or not, which may cause the robot 102 to immediately stop or slow down if it has not already. Detecting this sudden drop-off (i.e., increase in distance to the floor), the controller 118 may stop the robot 102 to avoid navigating over a potential cliff. Once stopped, the sensor 410 may continue to generate distance measurements along vector 408 as the robot 102 sits idle. If an escalator is present, the first moving step 402 may extend and descend in and out of the path of vector 408 causing distance measurements along vector 408 to be periodic. The periodic signal may include a large distance measurement or no distance measurement (i.e., the beam emitted never reflects back to the sensor 410) at the time illustrated in FIG. 4B(ii), followed by a sudden decrease in distance as the first moving step 402 extends into the path of vector 402 (along dashed line 416) as shown in FIG. 4B(i), followed by a gradual increase of distance measured as the first moving step 402 descends, or moves away from the stationary portion returning to FIG. 4B(ii) and repeating. Upon detecting such a periodic distance measurement while the robot 102 is idle, the controller 118 may assume an escalator is present.

Preferably, the sensor 402 detects cliffs and/or walls further than the maximum stopping distance of the robot 102. The maximum stopping distance may correspond to the maximum distance required to bring the robot 102 to a full stop when moving at either its current speed or maximum speed, and may be adjusted if, e.g., a payload is attached to the robot 102 which increases its mass and required stopping distance. It is preferred the cliffs are detected ahead of the maximum stopping distance such that, in the event the robot 102 detects a cliff caused by a moving step of an escalator, the robot 102 still has the capability to navigate away from the entrance of the escalator prior to navigating onto the moving steps 308. For instance, the robot 102 may not detect a cliff until the first moving step either moves down the escalator 302 or moves into the stationary portion 310, thereby making the cliff appear up to a distance 414 closer than where vector 408 first detected the cliff in FIG. 4B(i). Distance 414 is approximately the length of a moving step 308 of an escalator 302.

Regardless of the direction of motion of the escalator 302, i.e., upwards or downwards, the first moving step appearing and subducting (upward) or falling out of view (downward) generates a periodic distance measurement, as shown by the different lengths of vector 408 in FIG. 4B(i) and FIG. 4B(ii). Once the controller 118 stops the robot 102 due to the detection of a potential cliff, sensing the periodicity of the distance measurement of vector 408 may indicate that the cliff is an escalator. The periodic distance measurement may include, for an upward moving escalator 302, detecting a large distance or no distance measurement (FIG. 4B(ii), which should stop the robot 102) followed by a gradual decrease in distance measured as the first moving step 402 ascends into view (FIG. 4B(i)). As the first moving step continues upward/underneath stationary portion 310, a sudden increase in distance measured or lack of distance measured occurs as the first moving step 402 moves to its minimum distance 406 and is no longer in the path of vector 408. The distance of vector 408, over time, may comprise of an approximate saw tooth function, the period of this function corresponds to the period between sequential moving steps of the escalator 302 subtending beneath a stationary portion 310. For downward moving escalators, the periodic distance measurement arises when the sensor 410 detects the first moving step 404 when it is level with the floor (FIGS. 4A(i) and 4B(i)) with a small distance measurement, followed by the distance measurement increasing as the first moving step 404 moves down the escalator and/or out of view of vector 408 (FIGS. 4A(ii) and 4B(ii)), and once the next first moving step 404 appears the distance measurement returns to the small value measured initially, wherein the process repeats. Distance of vector 408, over time, may yield an approximate saw tooth function inverse to the saw tooth function of vector 408 for an upward moving escalator, the period of this function also corresponding to the period between sequential moving steps of the escalator 302 appearing from beneath a stationary portion 310 (i.e., steps/second).

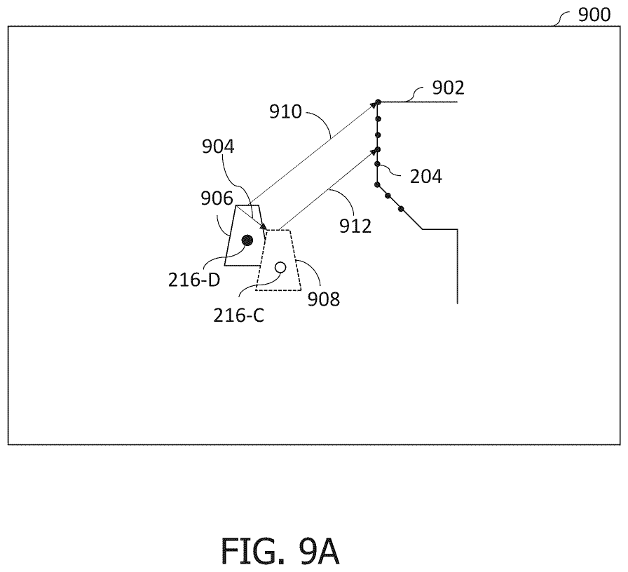

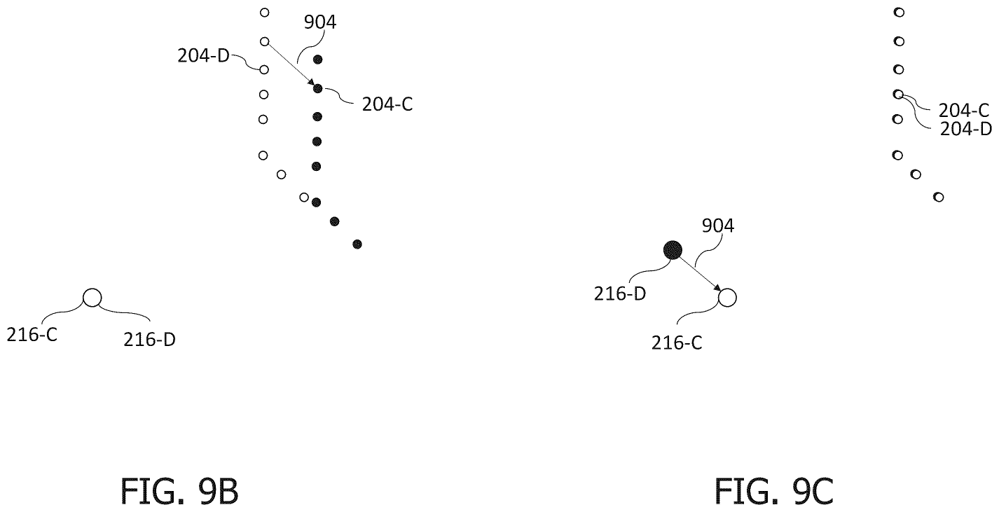

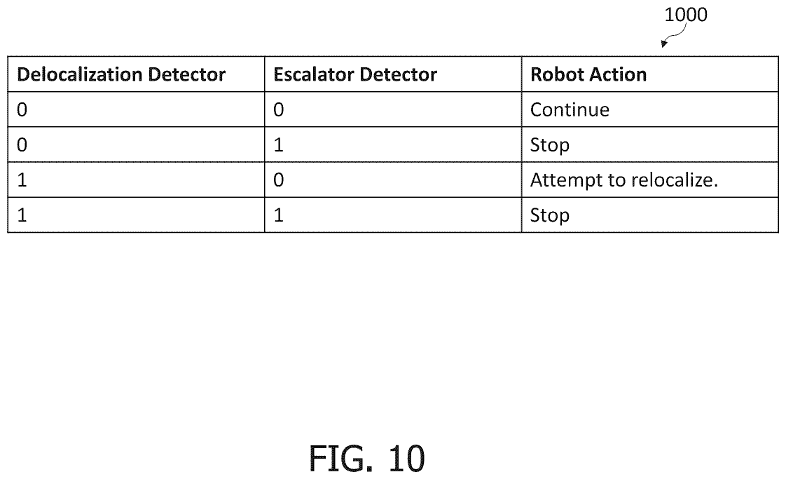

It is appreciated that use of this method for detecting the first moving step requires the robot 102 to detect cliffs far enough ahead of itself such that if the cliff is an escalator, the robot 102 is not resting on the first moving step upon stopping to avoid the perceived cliff. Assuming the robot 102 is able to localize itself with perfect accuracy, the use of cliff detection sensors should enable the robot 102 to stop safely before navigating onto the first moving step. However, a robot 102, which is delocalized, should behave differently and consider additional safety constraints, as will be discussed further in FIG. 9-10 below.

According to at least one non-limiting exemplary embodiment, sensor 410 may comprise a planar LiDAR sensor configured to collect distance measurements between the sensor 410 and various objects in the environment along a measurement plane. In some implementations, vector 408 may be illustrative of a slice of the plane wherein the remaining beams emitted by the LiDAR sensor 410 may be emitted along a plane orthogonal to the page and parallel to vector 408. In some implementations, the measurement plane may be parallel to or along the plane of the page and form a virtual curtain of beams 206 ahead of the robot 102, wherein any of the beams 206, yet no particular one, may detect cliffs ahead of the robot 102.

According to at least one non-limiting exemplary embodiment, sensor 410 may comprise a depth camera configured to generate distance measurements of a two-dimensional field of view. Use of a depth camera to sense the periodic motion of the first moving step 402 may be preferred as the expanded field of view of a depth camera, as compared to a planar LiDAR, may enable the robot 102 to sense the periodic motion from a further distance. For example, in the case of a planar LiDAR, the robot 102 may be required to move to the illustrated position in FIG. 4B(ii) where the length of vector 408 extends beyond the expected distance to an otherwise flat floor, the vector 408 represents a measurement along the measurement plane of the LiDAR. However, in the case of depth cameras, the periodic appearance and disappearance of the first moving step 402 may be detected upon the first moving step 402 coming into view of the depth camera (e.g., within the top portion of depth images, as shown in FIG. 4A(i-ii)) which may provide the robot 102 with additional time to stop and/or slow down prior to navigating close to a potential escalator. Further, in some cases, the periodicity of the first moving step (i.e., distances to region 414) may be detected sufficiently far away from the robot 102 such that the robot 102 does not need to stop.

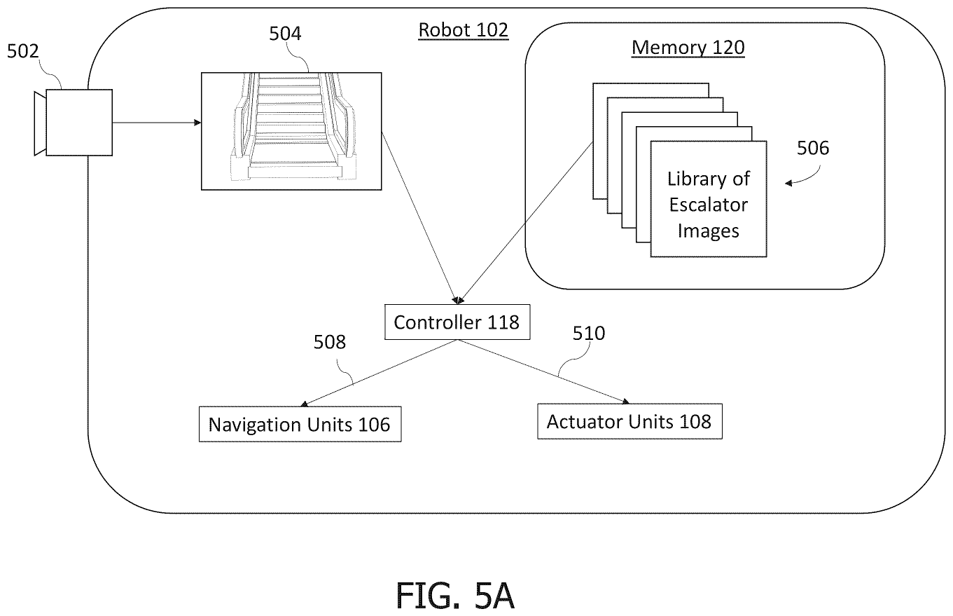

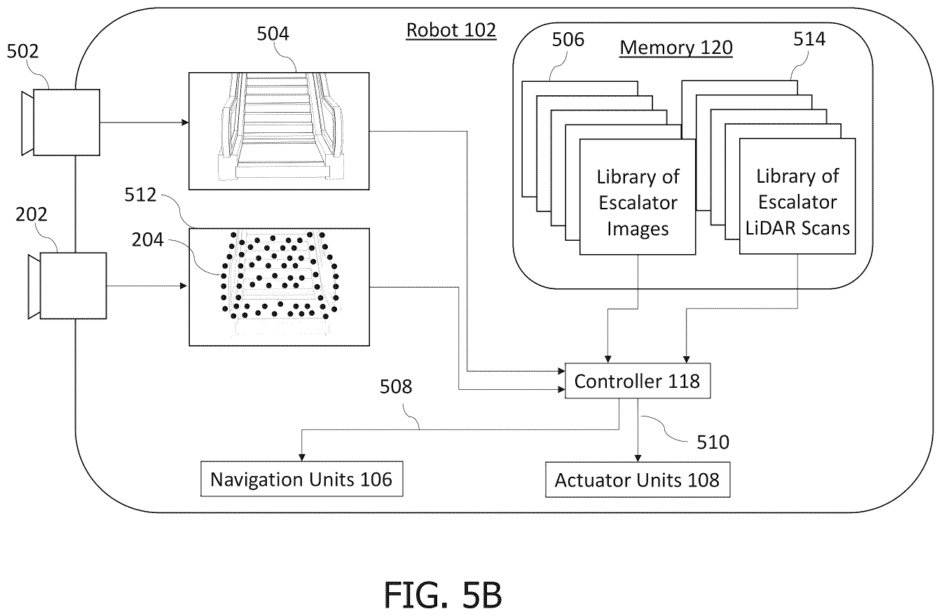

FIG. 5A is a functional block diagram illustrating a robotic system configured to identify escalators, according to an exemplary embodiment. A robot 102 may include a sensor 502, of exteroceptive sensor units 114, configured to take images of an environment. Such images may include depth images, color images, greyscale images, down-sampled images, and/or other images which depict a visual scene. Sensor 502 may produce an image 504 which depicts an escalator 202. The image 504 may be communicated to a controller 118 of the robot 102 and compared with a library of escalator images 506 stored in memory 120 of the robot 102.

The library of escalator images 506 may include a plurality of images which depict escalators 202 of various types/sizes, from various perspectives, and/or under varying lighting conditions. The library of escalator images 506 should be the same modality as the image 504 to simplify the comparison. That is, if image 504 is a greyscale image, images of the library of escalator images 506 may also be greyscale images, and same for depth images, RGB images, heat images, and the like. The images of the library of escalator images 506 may also include the same or similar resolution as the images 504 produced by the sensor 502. The library of escalator images 506 may be accessed by the controller 118 to enable the controller 118 to compare the image 504 to the library of escalator images 506, such that similarities may be detected. The similarities may correspond to detection of an escalator in the image 504.

Controller 118 may execute computer-readable instructions to compare the image 504 with a plurality of images from the library of escalator image 506 using any conventional method known in the art including, but not limited to, comparing histograms of color values of two images, template matching, feature matching, color distance, feature extraction, neural network(s) trained using the library of escalator images 506, and/or other methods of comparing images for similarities. Controller 118 may compare the input image 504 with any one or more images of the library of escalator image 506 to determine any similarities between the image 504 and escalators depicted in the library 506. For example, template matching or feature extraction may be utilized by the controller 118 applying various filters of the library 506 to identify specific features of an escalator 302 such as, without limitation, steps, handrails, balustrades, side walls, metallic plates, and the like. As another example, comparing a color distance, or color difference, between the input image 504 and any image of the library 506 may comprise the controller 118 comparing color values of pixels of the image 504 to color values of the images within the library 506. The controller 118 may, upon detecting a small change in color values between the image 504 and one or more images of the library 506 (e.g., less than a threshold difference), determine that an escalator 302 is depicted in the image 504, based on its similarity with images of escalators stored in the library 506.

If the controller 118 detects a substantial similarity (e.g., greater than a threshold, such as a 70% match or greater) between the input image 504 and, at least, one escalator image within the library 506, the controller 118 may determine that an escalator 302 is present. Accordingly, controller 118 may issue commands 508 to navigation units 106 to map the escalator on a computer-readable map such that the controller 118 may avoid the escalator. For example, the controller 118 may place a region on a computer-readable map around the detected escalator which defines an area the robot 102, under no circumstance, should enter. Navigation units 106 may, subsequently, reroute the robot 102 away from the escalator by updating a route of the robot 102 to cause the route to avoid the location of the escalator 302 on the computer-readable map, in other words identifying the escalator 302 on the computer-readable map as a no-go zone or a route not to travel. Controller 118 may also issue commands 510 to actuator units 108 to cause the robot 102 to stop, reverse, or turn away from the escalator 302 entrance.

In many instances, singular data sources may yield false positive escalator detections as a plurality of environmental conditions may cause image comparison models to predict an escalator when there is none. A more concerning situation would be false negatives, wherein an escalator is present, and the image comparison model predicts no escalator is present. Accordingly, FIG. 5B illustrates an expanded functional block diagram configured to identify escalators more robustly than the single modality used in FIG. 5A, according to an exemplary embodiment. In FIG. 5B, sensor 202 may comprise of a planar LiDAR or depth camera as shown and described in FIG. 2A(i-ii) above. Sensor 502 may comprise of a colorized (i.e., RGB, YGB, etc.) image camera. The modalities of these sensors are impactful as many escalators 302 comprise glass walls which are transparent to infrared beams 208 of a LiDAR/depth camera but are visible to optical/RGB cameras 502, yielding one of many a clear distinguishing trait of escalators as opposed to other corridors, cliffs and walls. Depth information from a LiDAR or depth camera may also provide for accurate distance measurements, more specifically width 322 (shown in FIG. 3B) and/or the step-like distances.

The controller 118 may embody one or more trained models which receive the incident sensor data, comprising of a colorized image 504 and a LiDAR scan 512 captured contemporaneously, and compares the data to reference libraries, now comprising a library of escalator images 506 and a library of escalator LiDAR scans 514. The library of LiDAR scans 514 should be of the same modality as the sensor 202 (e.g., planar LiDAR scans for a planar LiDAR sensor 202). A model, such as a convolutional neural network or other similar models, trained using two data sets of different modalities may then build a model of relationship between the LiDAR scans of escalators and the RGB images of the escalators. Such relationships may also be detected within the incident data 504, 512 to predict if such incident data contains an escalator. Advantageously, use of two sensors of different modalities may improve the predictive accuracy of the model embodied by the controller 118 by providing additional parameters of which the controller 118 to compare and build predictive relationships. For instance, a heavy correlation with black pixels and points 204 approximately in a row may correspond to a handrail, wherein searching for only black pixels or points 204 in a row may not be sufficient to predict a handrail is sensed. One skilled in the art may appreciate, however, use of added sensor modalities improves the robustness and accuracy of detecting escalators at the cost of increased memory occupied by library 514 and processing resources needed to run the more complex models. Such additional computation may be permissible if, upon detecting a width 322 of standard width (FIG. 3B) or a cliff (FIG. 4B(ii)), the robot 102 stops, thereby allowing for added time to process incoming sensor data.

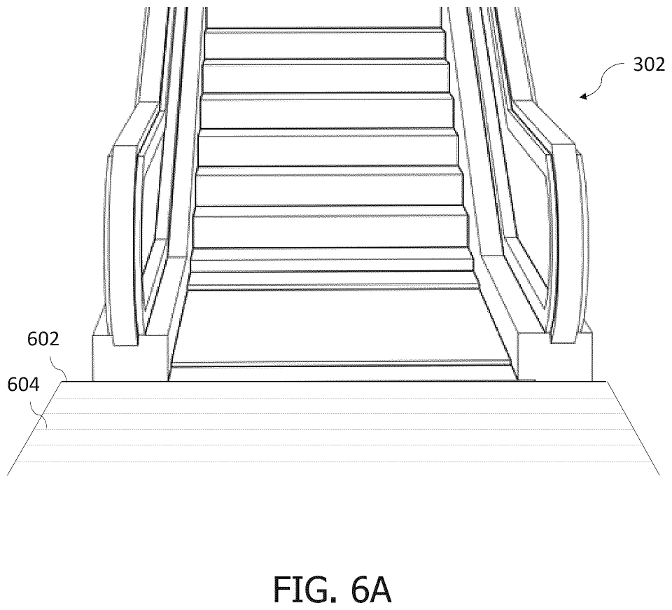

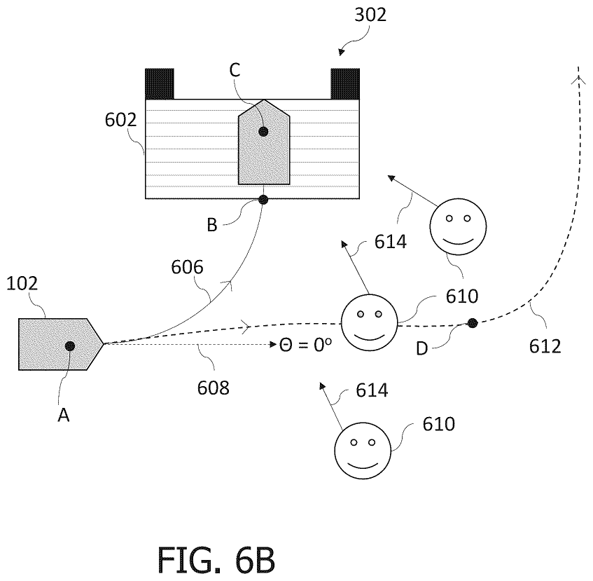

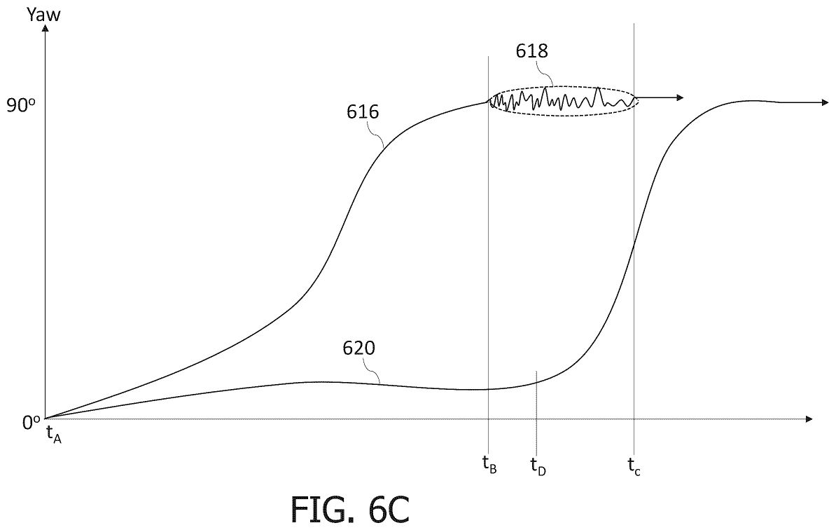

FIG. 6A illustrates an entrance to an escalator 302 comprising a metallic plate 602, according to an exemplary embodiment. One skilled in the art would appreciate that reference to metallic plates is akin to plates as discussed herein. Plates 602 are typically placed at the entrances to escalators 302 to house the electromechanical components of the escalator which are often audible and cause the plate 602 to vibrate. Such plates 602 may further include grooves 604 to enable visually impaired humans to sense the presence of an escalator using a cane. It may be desirable for a controller 118 of a robot 102 to determine if a robot 102 is navigating upon the plate 602 as navigating on the plate 602 may cause the robot 102 to move dangerously close to an escalator 302, especially if the robot 102 is at least partially delocalized.

Sensor units 114 of a robot 102 may include interoceptive sensors such as gyroscopes, accelerometers, and the like which measure the position (x, y, z) or displacement (dx, dy, dz) of the robot 102 over time. Data from such sensors may indicate the robot 102 is vibrating based on observing small displacements of the robot 102 over time that would appear as a noisy measurement from, e.g., a gyroscope. These vibrations may indicate to the controller 118 that the robot 102 is navigating upon a metallic plate 602 of an escalator 302. One skilled in the art would appreciate that vibrating of the robot 102 may correspond to minute or small displacements of the robot 102 in a given duration of time.

According to at least one non-limiting exemplary embodiment, a robot 102 may include one or more microphones. In some instances, data from the microphone may be utilized in addition to any of the methods discussed herein to identify a metallic plate 602, and, therefore, an escalator being present. For example, as a robot 102 navigates over a grated plate 602, the wheels vibrating produce noise that would be detected by the microphone. In some instances, the microphone may further detect audible machine noise from beneath the metallic plate 604, as the metallic plate 604 typically covers a machine pit that includes the motors and other mechanical equipment required to move the escalator 302. Typically, for heavy robots 102, such mechanical noise may be drowned out by the noise of the robot 102 driving over the grates 604 in the plate 602; however, if the robot 102 is idle or has stopped near or on top of the plate 602, the mechanical noise may be detected. Typically, such noise is of a particular, and consistent frequency bandwidth which may be band-pass filtered to be detected as an escalator.

FIG. 6B illustrates a robot 102 navigating a route 612 onto a metallic plate 602 of an escalator in a scenario wherein the robot 102 must navigate towards an escalator to avoid other collisions, according to an exemplary embodiment. As shown, a dashed line is a route 612 corresponding to a route which the robot 102 should follow if no objects obstruct the route 612. In some embodiments, robots 102 may be taught or trained by a user to follow a route 612 under user-guided control and, subsequently, repeat the demonstrated route autonomously. In the illustrated scenario, three humans 610 may approach the escalator following paths shown by arrows 614. The robot 102 has no prior information about the presence of such humans until it reaches location A as shown and detects them via sensor units 114. As the humans 610 approach the escalator, the robot 102 may attempt to re-plan its route 612 to avoid colliding with the humans. In re-planning the route 612, the controller 118 may adjust the route 612 such that the robot 102 navigates upward along the page until the route is modified as shown by route 606 due to the continued motion of the humans 612 towards the escalator. In some instances, the humans may stop completely prior to entering the escalator to allow the robot 102 to pass, but may, inadvertently, block the route 612 and cause the robot 102 to re-plan its path towards the escalator.

FIG. 6C illustrates data from a gyroscope configured to measure angular position and/or rotation rate of the robot 102, according to an exemplary embodiment. The first trace 616 represents the yaw angle of the robot 102 measured over time as the robot 102 executes route 606. The second trace 618 represents the yaw angle of the robot measured over time as if the robot 102 had executed route 612. The approximately 90° gradual turn of the robot 102 as the robot 102 executes route 612 is shown comprising little to no noise. Typically, when operating on smooth surfaces, the noise from a gyroscope may be predominately thermal noise which has been removed from both traces 616, 620 for clarity. The times at which the robot 102 reaches the various points A, B, C, D shown in FIG. 6B are denoted as t_{A}, t_{B}, t_{C}, and t_{D} respectively for reference.

However, upon the robot 102 encountering the metal plate 602 at time to the grooves 604 in the plate may cause the robot 102 to vibrate. Such vibrations are shown within envelope 618 of trace 616 that illustrates the sudden increase in noise due to vibrations of the robot 102 over the metallic plate 602. Further, metallic plates 602 may cover various motors, belts, and other mechanical components of the escalator 302, which further enhances the vibration experienced by the robot 102 navigating upon the plate 602, leading to increased noise in gyroscopic data. In some embodiments, wherein sensor units 114 include a microphone, such mechanical noise may also be detected audibly. An increase in noise may be sensed based on the controller 118 measuring the standard deviation of the signal and comparing it with a threshold for short periods of time. The noise may also be measured by subtracting movement caused by issued motor signals from measured changes in position of the robot 102 via a gyroscope. Noise may also be detected if the data from the gyroscope does not correspond to motion commands issued by the controller 118 to actuator units 108. To illustrate, the left portion of the trace 616 shows a smooth 90° turn along route 606, which is expected, based on the motion commands issued to actuator units 108 to follow the path 606, wherein any deviation from the expected smooth 90° may correspond to noise. The right portion of the trace 616 indicates the robot 102 is making small and rapid rotations when controller 118 is not issuing any such actuator commands to turn the robot 102 (i.e., the robot 102 moves straight along the metallic plate 602), which may, instead, be attributed to noise or vibrations. For example, the controller 118 is moving straight once the robot 102 reaches point B despite the yaw angle changing rapidly. In comparison to trace 620, which does not include the robot 102 navigating over a grated plate 602, does not include such noise and is a smooth and gradual 90° turn.

It is appreciated by one skilled in the art that other measurements from the gyroscope, such as pitch and roll measurements and/or time-derivatives thereof, may also exhibit excessive noise due to the robot 102 navigating over a metallic plate 602 comprising grooves 604. The various rotational measurements from the gyroscope along any principal axis may include an increase in random variations, or noise, at the same time t_{B} which do not correspond to motor commands from the controller 118. By observing the increase in noise at a same time t_{B} for yaw, pitch, and roll axis (and time derivatives thereof), controller 118 may correlate such increase in noise as being attributed to the robot 102 navigating over a bumpy surface such as plate 602. Although use of gyroscopic data alone may not be sufficient in detecting escalators, detecting the robot 102 navigating over a potential metallic plate 602 of an escalator 302 may cause the robot 102 to stop and utilize other methods of this disclosure to verify that an escalator 302 is present (i.e., verify the robot 102 is not simply navigating over a bumpy floor). As one non-limiting exemplary embodiment, once stopped upon a grated plate, the robot 102 may utilize a microphone to listen to mechanical whirring of the components housed below the metallic plate 602 of the escalator. The whirring should similarly appear as a roughly constant center frequency (e.g., based on the speed of the motors/staircase/walkway), which is only detected upon stopping and not detected in other areas of the environment.

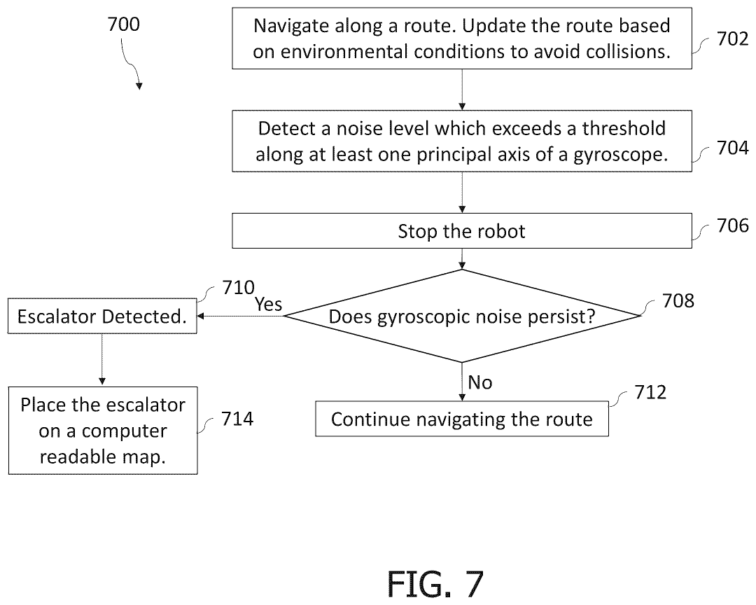

FIG. 7 is a process flow diagram illustrating a method 700 for a controller 118 to detect an escalator based on gyroscopic data, according to an exemplary embodiment. Steps of method 700 may be effectuated via controller 118 executing computer-readable instructions from memory 120.

Block 702 includes the controller 118 navigating a robot 102 along a route. Block 702 further includes the controller 118 updating the route based on environmental conditions to avoid collisions between the robot 102 and objects. The updates to the route may be in response to static or moving objects, detected via exteroceptive sensor units 114 as obstructing the route, thereby causing the robot 102 to navigate around the detected objects. By performing any updates or changes to the route in response to the detected objects, there may exist a risk that the updates may cause the robot 102 to navigate close to unforeseen hazards, such as escalators 302. As discussed above, escalators 302 pose a unique hazard for robots 102, as the robot 102 must stop or turn away prior to navigating onto the first moving step because navigating onto the first moving step may carry the robot 102 onto and over the escalator 302.

In some instances, the objects may completely obstruct the path and leave the robot 102 with no viable collision-free path, wherein the robot 102 may stop and (i) wait for the objects to move or be moved and/or (ii) request for a human to assist the robot 102 (e.g., by having the human clear the objects from the path or having the human manually move the robot 102).

Block 704 includes the controller 118 analyzing gyroscopic measurements and detecting a noise level which exceeds a threshold along at least one principal axis of the gyroscope. The principal axis corresponding to (x, y, z) axis, wherein the gyroscope measures rotation position and/or time rate of change along each axis (roll, pitch, yaw) and/or d/dt(roll, pitch, yaw). The noise may be measured as a signal to noise ratio (“SNR”), wherein the signal corresponds to an expected rotation of the robot 102 given actuator unit 108 signals from controller 118 which move the robot 102 along the route and the noise corresponds to any deviation from the expected rotation rate, accounting for thermal/background noise. As shown in FIG. 6B-C after time t_{B}, the robot 102 navigates straight and expects no change in its yaw angle; however, the yaw angle is changing rapidly due to vibrations caused by the robot 102 navigating over a grooved metallic plate 602.

In some embodiments, identifying a rapid change in time derivative measurements d/dt(roll, pitch, yaw) may indicate that the robot 102 is vibrating. For example, vibrations may cause the robot 102 to randomly be displaced by small amounts, wherein the time derivative of these displacements may rapidly change from positive to negative without the controller 118 issuing any such control signals to cause the robot 102 to rapidly change its rotation rate.

Block 706 includes the controller 118 stopping the robot 102. It may be advantageous to stop the robot 102 as a safety measure upon the controller 118, even suspecting an escalator is present, due to vibrations caused potentially by a metallic plate 602.

Block 708 includes the controller 118 determining if the gyroscopic noise persists. As the robot 102 is stopped, it is expected that vibrations caused by the robot 102 navigating over a grated surface will also stop. One skilled in the art may appreciate that thermal noise may always exist in measurements from a gyroscope; however, thermal noise is typically small compared to the vibrations of the robot 102 moving over the metallic plate 602.

Upon the controller 118 determining the gyroscopic noise persists, the controller 118 moves to block 710.

Upon the controller 118 determining the gyroscopic noise does not persist, the controller 118 moves to block 710. Since the robot 102 is stopped, any excess gyroscopic noise caused by the robot 102 navigating on top of the metallic plate 602 would have ceased.

According to at least one non-limiting exemplary embodiment, while the robot 102 is stopped, the controller 118 may utilize additional sensor data to confirm the presence of an escalator beyond the gyroscopic noise. For instance, while stopped, a microphone may be utilized to listen to potential mechanical (audible) noise cased by the machinery beneath a metallic plate 602. If the gyroscopic noise desists, and audible mechanical noise is detected, the controller may move to block 710. Otherwise, the controller 118 may continue to block 712. In other non-limiting exemplary embodiments, while the robot 102 is stopped, image analysis may be performed, as shown and described in FIGS. 3A-C and 5A. In other non-limiting exemplary embodiments, while the robot 102 is stopped, the controller 118 may receive depth measurements from a LiDAR or depth camera which includes a periodic distance signal due to the first moving step appearing as the steps of the escalator 302 move, as shown and described in FIG. 4A-B. Any or all of these methods disclosed herein may also be readily utilized in conjunction with the gyroscopic data, as appreciated by one skilled in the art, to further improve the accuracy of escalator detection.

Block 710 includes the controller 118 detecting an escalator 302. The detected escalator 302 may be placed onto a computer-readable map used by the controller 118 to navigate the robot 102 through the environment. The escalator may be represented on the map using a “no-go zone”, or region which under no circumstances is the robot 102 to navigate therein. The route may be updated or changed to cause the robot 102 to navigate substantially far from the escalator 302. For example, the controller 118 may impose a no-go region which surrounds the escalator 302 and metallic plate 602, the no-go region corresponds to a region on the computer-readable map of which the robot 102, under no conditions, is to navigate within.

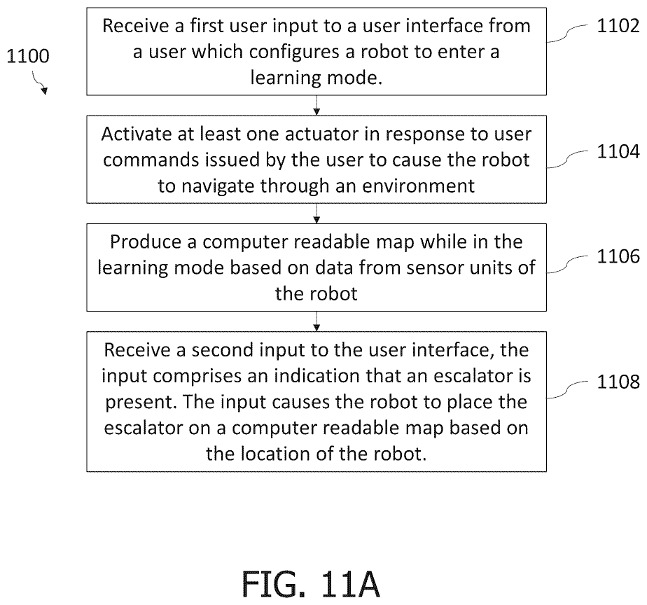

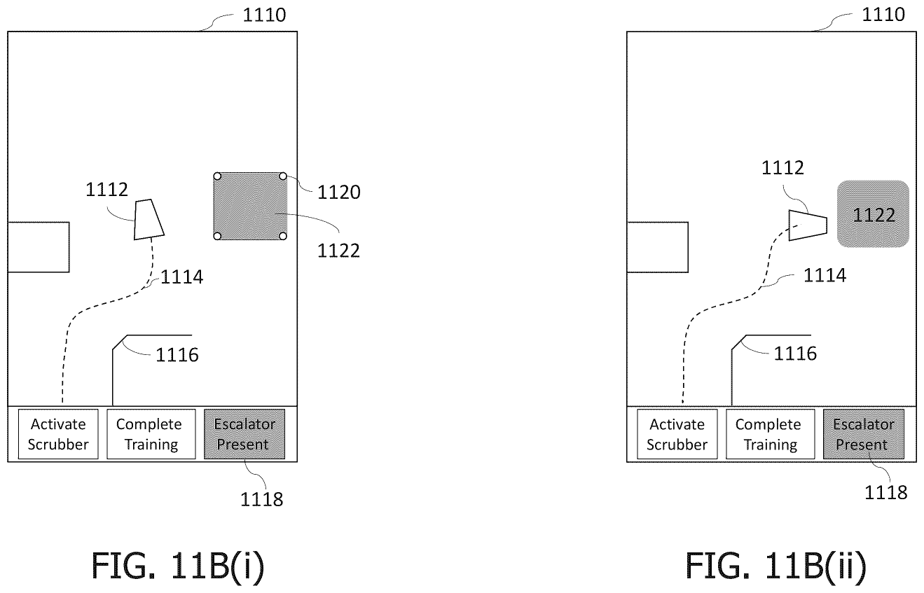

Block 714 includes the controller 118 placing the detected escalator on a computer-readable map. The escalator may be placed onto the computer-readable map by the controller 118 imposing a no-go zone or region in front of the robot 102, the region corresponding to an area within which the robot 102 should avoid under all circumstance. The size of the no-go zone may correspond to typical widths of escalators, enlarged slightly to provide a margin of error for safety. Alternatively, in some embodiments, the controller 118 may analyze images captured from a camera to determine the true location and size of the escalator using, e.g., the image comparison methods shown in FIG. 5A-B or other applicable methods of this disclosure, such as LiDAR depth measurements. Another exemplary method for placement of an escalator on a computer-readable map using the no-go zone region is shown in FIG. 11B(ii) below. Using the computer-readable map, the controller 118 may determine if a viable (i.e., collision free) route is navigable to enable the robot 102 to move away from the escalator safely. However, the robot 102 may not always be able to reroute away from the escalator, wherein the robot 102 may request human assistance (e.g., via SMS message or another alert such as one on user interface units 112).

Although process 700 discusses a method for detecting escalators 302 using gyroscopic data, one skilled in the art may appreciate that other forms of escalator detection disclosed herein may also be used in conjunction with the gyroscopic data to detect an escalator 302. Using multiple escalator detection methods may improve the overall accuracy of escalator detection by a robot 102 and may solve deficiencies in any individual method disclosed herein. According to at least one non-limiting exemplary embodiment, controller 118 may, in addition to detecting persistent gyroscopic noise in block 708, utilize optical flow to sense movement of the steps 308 of the escalator, as shown and described above in FIG. 3-4 in order to differentiate from bumpy floors and an escalator entrance while stopped at block 706. According to at least one non-limiting exemplary embodiment, the controller 118, after detecting gyroscopic noise, may capture an image of the environment surrounding itself and compare the image to a library of escalator image 506 to identify any similarities between the captured image and images of escalators, as shown and described in FIG. 5A-B. Advantageously, once the robot 102 has stopped in block 706, additional computational resources may be utilized as the robot 102 is idle as compared to typical operation, wherein substantial computing bandwidth is occupied by mapping, localization, and path planning.

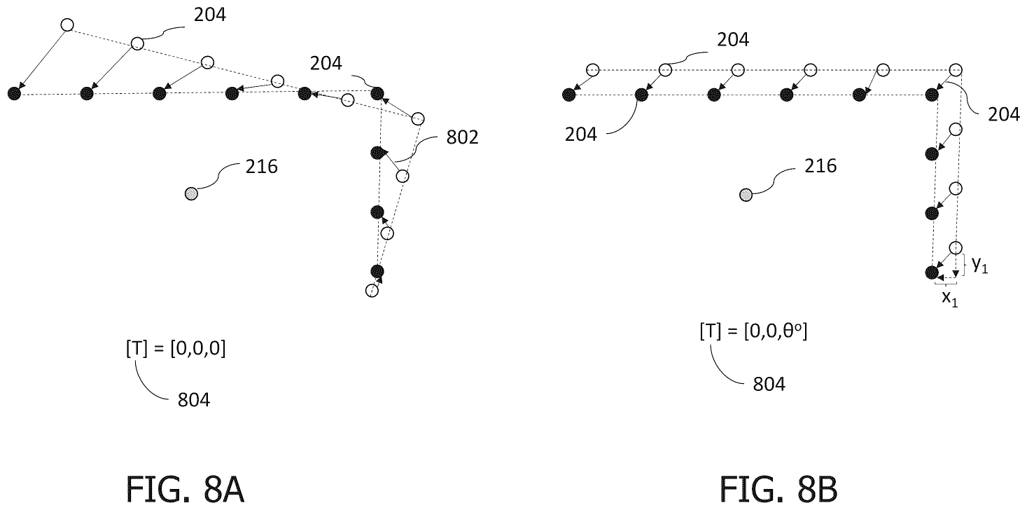

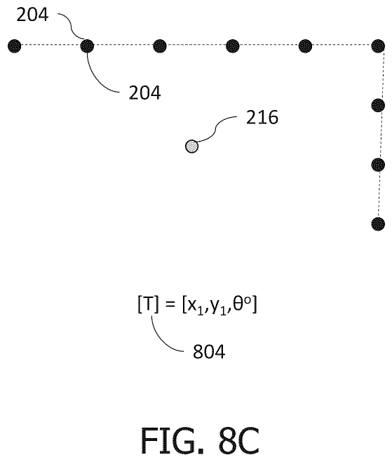

FIG. 8A-C illustrates a process of scan matching, in accordance with some embodiments of this disclosure. Scan matching comprises a controller 118 of a robot 102 determining a mathematical transformation which aligns points 804 of a first scan to points 804 of a second scan. This transformation may denote the change of position of the robot 102 between the first and second scans, provided the object is stationary. First, in FIG. 8A, two sets of scans from a LiDAR sensor 202, shown in FIG. 2A(i-ii) above, are illustrated. A first scan may generate a plurality of points 804 shown in black and a second, subsequent scan may generate a plurality of points 804 shown in white. The spatial difference between the two sets of points 804 may be a result of a robot 102 comprising the sensor 202 moving while the objects sensed are static. The reference frame illustrated is centered about the robot origin 216. More specifically, during the period between the first and second scans, the robot 102 rotates by 0° and translates a distance x₁, y₁. The two sets of points 804 may localize the same objects, such as a corner of a room, for example.

Scan matching comprises a controller 118 of the robot 102 determining a transformation 804 along x, y, and θ which aligns the two sets of points 804. That is, the transformation 804 minimizes the spatial discrepancies 802 between nearest neighboring points of the two successive scans. Starting in FIG. 8A, controller 118 receives the two sets of points 804 (white and black) and determines a rotation of θ° may reduce the magnitude of discrepancies 802. As shown in FIG. 8B, the controller 118 has applied the rotation of 0° to the second set of points 804. Accordingly, transformation 804 is updated to include the rotation of 0°. Next, controller 118 may calculate a spatial translation of the second set of points 804, which minimizes discrepancies 802. In this embodiment, the translation includes a translation of y₁ and x₁ as shown, wherein y₁ and x₁ may be positive or negative values. FIG. 8C illustrates the two sets of points subsequent the controller 118 applying the translation of x₁ and y₁ to the second set of points 804. As shown, discrepancies 804 vanish and the two sets of points 804 align. Accordingly, controller 118 updates transform 804 to include the translation of [x₁, y₁]. In some instances, perfect alignment may not occur between the two sets of points 804, wherein transform 804 is configured to minimize discrepancies 802.

It is appreciated that scan matching may include the controller 118 iteratively applying rotations, translations, rotations, translations, etc. until discrepancies 802 are minimized. That is, controller 118 may apply small rotations which reduce discrepancies 802, followed by small translations further reducing discrepancies 802, and iteratively repeat until the discrepancies 802 no longer decrease under any rotation or translation. Controller 118 immediately applying the correct rotation of 0° followed by the correct translation of [x₁, y₁] is for illustrative purposes only and is not intended to be limiting. Such iterative algorithms may include, without limitation, iterative closest point (“ICP”) and/or pyramid scan matching algorithms commonly used within the art.

Transform 804 may denote the transformation or change in position of the object of which points 804 localize, assuming the sensor location is static between the two scans. From a reference frame of a robot 102, which does move, the apparent change in location of static objects are indicative of changes in the robot 102 position. Accordingly, scan matching, in the robot 102 frame of reference centered about robot origin 216, may be utilized to determine motions of the robot 102 between two scans. That is, the robot 102 may translate and rotate by an amount denoted by transform 804 during the time between acquisition of the first set of points 804 and the second set of points 804 from the same sensor 202.

Although illustrated in two dimensions, scan matching between two sets of points 804 may occur in three dimensions. That is, transform 804 may further include [z, pitch, roll] transformations which cause the two sets of points 804 to align in some non-limiting exemplary embodiments.

Scan matching may enable a controller 118 to determine if the robot 102 is delocalized. A robot 102 is delocalized when the true position of the robot 102 does not match with a calculated position of the robot 102 by the controller 118. For example, by integrating actuator signals over time, controller 118 may calculate the robot 102 position relative to a starting location (e.g., world origin 220 or other landmark), thereby enabling the controller 118 to build computer-readable maps of the environment, which include the location of the robot 102 in the world frame (i.e., frame of reference centered about the static world origin 220). In some instances, however, data from sensor units 114 and/or navigation units 108 may become noisy, fail, or experience some external phenomenon (e.g., wheel slippage), which causes the measured location of the robot 102 by the controller 118 to be different from the actual location of the robot 102. To illustrate, FIG. 9 depicts a computer-readable map 900 produced by a controller 118 of a robot 102 during navigation, according to an exemplary embodiment.

The computer-readable map 900 may include the locations of various static objects, or objects which are consistently (e.g., over multiple measurements, trials, hours, days, etc.) in the same location and do not move, such as object 902. Object 902, or the surfaces thereof, may be sensed by LiDAR sensors 202 and represented by a plurality of points 204 which may be converted to pixels on the computerized map 900. The computer-readable map 900 may further include a footprint 906 of the robot 102 corresponding to the calculated location of the robot 102 in the environment as determined by the controller 118 (i.e., footprint 906 is subject to error due to delocalization). In the illustrated scenario, the robot 102 is delocalized, wherein the controller 118 calculates the position of the robot 102 as being at location of footprint 906 when, in the physical world, the robot 102 is at the location of footprint 908. The delocalization is shown by ray 914 which represents the spatial displacement between where the controller 118 believes the robot 102 to be and where the robot 102 truly is.

To determine that the robot 102 is delocalized, controller 118 may perform scan matching, as described above. The first set of points 204 may arrive from a scan from a sensor 202 while the robot 102 is at the illustrated position. The second set of points 204, of which the first set of points 204 are to be aligned with, may be received during prior navigation at the location, wherein the same static object 902 was previously detected. That is, to determine the magnitude and direction of the delocalization, scan matching may be performed using the current scan and prior scans (taken when the robot 102 was not delocalized, e.g., a previous day) of the static object 902. To illustrate further, using the map 900, one ray 910 is shown corresponding to a beam 208 from the sensor 202. If the robot 102 is at the location of footprint 906 on the map 900, controller 118 expects a distance measurement, as shown by the length of ray 910. However, in actuality, the sensor 202 will produce a distance measurement shown by the length of ray 912, which is of different length than ray 910. The different lengths of rays 910 and 912 may indicate to the controller 118 that the robot 102 is, at least, partially delocalized.

While at the location of footprint 906, controller 118 expects the sensor 202 to produce a plurality of points 204 which denote the surface of object 902. However, due to the delocalization of the robot 102, the controller 118 instead receives a different set of points 204 which represent the surface of object 902. As shown on the map 900, the two sets of points 204 coincide on the surface of object 902, but are defined with respect to two different robot origins 216: the delocalized origin 216-D (grey) and the correct origin 216-C (white). FIG. 9B shows the two sets of points 204, the two sets include a reference set (black) and a current set (white), according to an exemplary embodiment. The reference set may comprise a reference scan captured by a sensor 202 during a prior navigation of the robot 102 at the location nearby object 902. For example, the robot 102 may be shown or demonstrated a route to recreate, wherein the reference scan may be acquired during the training and utilized as the reference during later autonomous operation. The reference points 204-C may also correspond to averages of all the locations where object 902 was previously sensed. The current set of points 204-D denote the points 204 received by the sensor 202 at the present time (i.e., after the reference scan is collected). Taking both the reference points 204-C and current, delocalized points 204-D within the robot centric reference frames (i.e., aligning both origins 216-C and 216-D) causes the points 204-C, 204-D of the two sets of points to not align. The discrepancy between the two sets of points 204 may correspond to the direction and magnitude of the delocalization. Accordingly, controller 118 may perform scan matching to align the two sets of points, as shown in FIG. 9B(ii). The scan matching may produce a transform shown by ray 904, which denotes the linear shift of the current set of points 204-D towards the reference points 204-C. In some instances, the scan matching may further include rotations which have been omitted from the exemplary embodiment for clarity.

The ray 904 may denote magnitude and direction of the delocalization. Ray 904 is shown in FIG. 9A as reference and in FIGS. 9B(i) and 9B(ii) to illustrate the geometry of the delocalization. The controller 118 may accordingly adjust the position of the footprint 906 on the map 900 to the location of footprint 908.

Delocalization often occurs in varying magnitudes. Typically, robots 102 are always delocalized to some degree and continuously re-localize themselves onto maps 900. These delocalization's are often small, e.g., on the order of magnitude of millimeters or centimeters. In rarer instances, however, robots 102 may be substantially delocalized by larger amounts, e.g., on the order of tens of centimeters or more. Controller 118 may determine if the robot 102 is slightly or very delocalized based on the discrepancies between a current measurement and a reference measurement from a sensor 202. As used herein, delocalization may be denoted as “weak” or “strong”. Weak delocalization includes typical, small or zero localization errors, while strong delocalization includes large localization errors, large and small being defined with respect to a threshold value of ray 904 and operational safety of the robot 102. For instance, larger robots 102 may include a lower threshold for delocalization as larger robots pose a greater risk when delocalized than a smaller robot. The specific value of ray 904, which defines a “strong” or “weak” delocalization, may be based on the amount of delocalization which is tolerable by the robotic system which further depends on sensory resolution, calibration, sensor layouts, applicable safety standards and the like. Strong delocalization may further cause scan matching to fail (i.e., be unable to further minimize a discrepancy 802 larger than a threshold) if the discrepancy between the reference measurement and current measurement are substantially different. In some instances, being delocalized may pose a high risk for a robot 102 to navigate, especially in environments which include escalators 202. A delocalized robot 102 may believe it is navigating in a safe region when, in actuality, the robot 102 is approaching an escalator 202. The amount of delocalization, i.e., strong or weak, may also factor into the decisions made by controller 118 when operating in environments with escalators 202. Accordingly, controller 118 may adjust the behavior of a robot 102 upon detecting the robot 102 is delocalized if escalators 202 are present in the environment as discussed next in FIG. 10.

To illustrate, a robot 102 may learn a route via user demonstration, wherein the user never teaches the robot 102 to navigate nearby an escalator. Absent any dynamic objects in the environment, the robot 102 should repeat the route as taught without error, wherein detecting escalators 302 should not be necessary absent localization errors. However, when dynamic objects are introduced to the environment, such as humans or other robots 102, the robot 102 may be required to deviate from the trained path on occasion to avoid collisions. The amount of deviation from the trained route may be proportional to how well the robot 102 is able to localize itself, wherein a poorly localized robot 102 may be less inclined to deviate from the trained route. Such permissible deviation from a trained route may be based proportionally on the magnitude of delocalizations detected from LiDAR scans using scan matching.

FIG. 10 illustrates a table 1000, which includes outputs from a delocalization detector, an escalator detector, and a robot 102 action in response to these two outputs, according to an exemplary embodiment. The delocalization detector may include the methods for controller 118 to determine if the robot 102 is delocalized as shown and described in FIG. 9A-B above. A value of zero (0) corresponds to no delocalization or weak/permissible delocalization while a value of one (1) corresponds to the robot 102 being delocalized or a strong/impermissible delocalization.

Weak delocalization may include errors in localization (determined via scan matching), which are within tolerable levels to operate the robot 102. The error in a weak localization may range from no error to an error small enough to be deemed insufficient to pose any risk to the robot 102 and/or hinder task performance. The localization error in a strong delocalization may be large enough such that it is unsafe to operate the robot 102 and/or hinders task performance. The amount a robot 102 is delocalized may be quantified based on the magnitude of rays 904 shown in FIG. 9B-C above. The specific numeric thresholds for what may be deemed safe or unsafe, permissible or impermissible, may further dependent on the size, shape, tasks, and environment of the robot 102. For example, small robots 102 operating in open, empty spaces may be more tolerable to delocalization than a large robot operating in crowded, human-filled spaces. One skilled in the art may appreciate that any localization of the robot 102 may always contain some residual error due to resolution limits of its sensor units 114.

The escalator detector may include any one or more of the escalator detection methods described herein. The methods may be utilized independently or in conjunction with one another. For example, a controller 118 may utilize three independent escalator detection methods: (i) sensing optical flow of moving steps (FIG. 3A-C), (ii) determining a similarity of an image with a library of escalator images 506 (FIG. 5A), and (iii) sensing vibrations using data from a gyroscope (FIG. 6A-C). Each of these methods utilize data independently gathered from separate sensor units 114 of the robot 102. Each of these methods may output a result indicating the presence, or lack thereof, of an escalator. Based on these three results, controller 118 may determine if there is a strong likelihood that an escalator 302 is present or a weak likelihood that an escalator 302 is present. To illustrate, if only one method indicates the presence of an escalator 302 while the other two do not, the detection may be considered weak and is represented by a zero (0) value in table 1000. Conversely, if two or more of these three methods indicate the presence of an escalator 302, the escalator detection may be strong, corresponding to a value of one (1) in table 1000. In some instances, multiple methods may be utilized to confirm an initial method, such as image data being utilized to determine if detected gyroscopic noise/vibrations is caused by a grated metallic plate 602.

In row one (1) of the table 1000, if the robot 102 is weakly delocalized and weakly detects an escalator, the robot 102 may continue navigating. Since the controller 118 localizes the robot 102 to within a tolerable range (i.e., weakly delocalized), there may be lower risk of the robot 102 navigating into an escalator 302. This risk is further reduced by the weak detection or no detection of an escalator via escalator detector(s).

In row two (2) of table 1000, if the robot 102 is weakly delocalized and strongly detects an escalator 302, the controller 118 causes the robot 102 to stop. Even if the controller 118 accurately localizes the robot 102, the strong likelihood of an escalator 302 being present may provide sufficient risk to cause the robot 102 to stop. Since the controller 118 determines the robot 102 is only weakly delocalized, the controller 118 may map the location of the escalator on a computer-readable map of the environment. In some instances, the controller 118 may place a no-go zone on a computer-readable map on top of the escalator and attempt to plan a route away from the escalator/no-go zone; however, in some instances, it may not be possible and the robot 102 may require human assistance and request such via, e.g., SMS message, audible alarms, or other methods disclosed herein.

In row three (3) of table 1000, if the robot 102 is strongly delocalized and weakly detects an escalator 302, the controller 118 attempts to re-localize the robot 102. The controller 118 may re-localize the robot 102 by sensing various objects and comparing the locations of those sensed objects to objects on a reference map, as shown in FIG. 9A-B above. If the controller 118 is able to localize the robot 102, the controller 118 may continue executing its assigned task, otherwise the controller 118 stops the robot 102. If the controller 118 is unable to delocalize, the robot 102 may require human assistance. The robot 102 should be delocalized before attempting to continue its tasks as delocalization may cause task performance to degrade.

In row four (4) of table 1000, if the robot 102 is strongly delocalized and strongly detects an escalator 302, the controller 118 causes the robot 102 to stop. This is the highest risk scenario as a delocalized robot 102 may accidently navigate into an escalator 302 while incorrectly believing it is navigating elsewhere. Further, the presence of escalators 302 may drastically heighten the risk of a delocalized robot 102 moving/navigating near the escalators 302.

It is appreciated that the values in table 1000 are not limited to being binary values. For example, the values may be any value ranging from [0, 1]. The range of values may represent the “strength” of a strong delocalization or confidence that the escalator detectors sense an escalator 302. To illustrate for the delocalization detector, if the controller 118 senses small discrepancies in its localization parameters, the value of the delocalization detector output may be 0.1, 0.2, etc., whereas the controller 118 detecting large discrepancies may cause the delocalization detector to output values of 0.9, 0.95, etc.

The escalator detectors of this disclosure may be binary outputs or confidence-based outputs. To illustrate, sensing optical flow of moving steps either occurs or does not occur, wherein the output of an escalator detector using optical flow may be a binary output. For image comparison, however, the similarities between an input image 504 and images of a library 506 is not binary. For example, the input image 504 and a best-match image from library 506 may be 50%, 60%, 99%, etc. similar. Accordingly, the output from the image matching algorithm may be non-binary and based on the similarities of the input image 504 and one or more best-match images from library 506, as well as a confidence parameter. To aggregate both the binary and non-binary outputs, controller 118 may consider each using a normalized weighted summation or average value. For example, equation 1 shows the output value of an escalator detector D as:

D=AM₁+BM₂+CM₃

Where A, B, and C are constant weights of values ranging from [0, 1]. Mₙ represents the output from an n^{th} method of escalator detection used comprising a value ranging from [0, 1]. For example, M₁ may correspond to the detection or lack thereof of moving steps via optical flow and may take values of 0 or 1 (which may, in some instances, include a confidence). M₂ may correspond to escalator detection via image comparison, M₂ comprising values ranging from [0, 1] based on the confidence or similarity of an input image 504 with one or more images of a library 506 (e.g., M₂ may be 0.6 if the input image is 60% similar to an image within the library 506 with constant B having a value of one (1) in this embodiment). The constant weights may be adjusted, based on the parameters of the robot 102 and the accuracy of the various escalator detection methods. One skilled in the art may appreciate that the weights A, B, C, etc. may depend on the parameters of the robot 102. For example, robots 102 comprising high resolution cameras may weight image comparison more heavily than for robots 102 with low resolution cameras. Equation 1 may further include a normalizing constant such that the value of D ranges from [0, 1] or may be an input to a sigmoid activation function for D, wherein D takes values of 0 or 1 based on the result of the sigmoid. In some embodiments, Mₙ may be further adjusted by a confidence parameter. For instance, an image comparison may indicate an input image is 60% similar to reference images of escalators, wherein the controller is 90% confident of the 60% figure. Thus the 60% similarity may be adjusted by a factor of 0.9 or other factor, based on the confidence of the output prediction.

In some embodiments, robots 102 may be trained to navigate routes while under user-guided control, wherein an operator drives, pushes, leads, etc. the robot 102 through the route one or more times and stores the route data in memory 120. The route data may be recalled by controller 118 at a later time to autonomously cause the robot 102 to recreate the route. Accordingly, it is highly unlikely that an operator may train a route which causes a robot 102 to navigate onto an escalator 302. The two most likely scenarios which may cause a robot 102 to deviate from the trained route onto an escalator 302 include: dynamic objects causing the robot 102 to reroute (FIG. 6B) or delocalization. Advantageously, by combining the various methods of escalator detection and utilizing these methods while the robot 102 is delocalized, controller 118 is able to safely control a robot 102 in environments comprising escalators, drastically reducing the likelihood that the robot 102 navigates onto an escalator 302 accidentally.

Discussed above are various systems and methods for robots 102 to automatically detect escalators during operation. In some embodiments, robots 102 may be trained to execute certain tasks, such as navigating routes. These routes may be demonstrated by an operator pushing, driving, leading, or otherwise moving the robot 102 through the route, wherein the controller 118 stores the location of the robot 102 throughout to later reproduce the route. It may be advantageous to, during the training, ask the operator if an escalator 302 is present in the environment. FIG. 11 is a process flow diagram illustrating a method 1100 for a controller 118 to learn a route from a human user within an environment which includes an escalator 302, according to an exemplary embodiment. Steps of method 1100 may be effectuated via controller 118 executing computer-readable instructions from memory 120.

Block 1102 includes the controller 118 receiving a first user input from a user which configures the robot 102 in a learning mode. The user input, received by user interface units 112, may include the user pressing a learning mode button, sensing an operator key (e.g., inserted into a keyhole or detected via RFID), taping options on a touch screen, and/or other user inputs described in FIG. 1A above. While in the learning mode, the operator may move the robot 102 to a known location in the environment prior to demonstrating the route/task to provide the controller 118 with an initial location of the robot 102 within its environment. For example, the controller 118 may utilize sensor units 114 to detect a known feature or object in the environment such as a computer-readable code (e.g., a quick-response code affixed to a wall) or other known objects to determine its initial location. For simplicity, the feature or computer-readable code may be considered as the world origin 220; however, the world origin 220 may be any fixed location. From the initial location, the user may begin training the robot 102 via demonstration of the task/route by manually or semi-manually controlling the robot 102.

Block 1104 includes the controller 118 activating at least one actuator in response to user commands issued by the user to cause the robot 102 to navigate through an environment. The user commands may include any command issued by the user to the robot 102 to cause the robot 102 to execute a motion. For example, robot 102 may include a steering wheel or joystick coupled to pedals which enables the user to manually control the direction and speed of travel of the robot 102, wherein the actuator unit 108 signals produced in response to the user inputs to the wheel/joystick/pedals may cause wheels or treads of the robot 102 to rotate. In some embodiments, robot 102 may include various actuatable features (e.g., a floor cleaning robot may include one or more activatable scrubbing pads). The user may control such features via inputs to user interface units 112, wherein the controller 118 stores the inputs provided by the user for later reproduction of the actions of these features. To illustrate, a robot 102 may include a floor-cleaning robot comprising an activatable scrubbing pad, wherein the user may, during the training, activate/deactivate the scrubbing pad where cleaning is desired. The controller 118 may store the locations where the scrubbing pad was activated or deactivated when later reproducing the route autonomously.

Block 1106 includes the controller 181 producing a computer-readable map while in the learning mode, based on data from sensor units 114 of the robot 102. The computer-readable map may include the location of the robot 102 and various objects within the environment sensed by sensor units 114. The computer-readable map may further include the route, or portion of the route, of which the user has demonstrated. The computer-readable map may be two-dimensional or three-dimensional.

Block 1108 includes the controller 118 receiving a second input to the user interface. The second input comprises an indication that an escalator 302 is present. The input causes the robot to place the escalator on a computer-readable map based in part on the current location of the robot 102 and the second user input. During the training described above in blocks 1102-1106 above, user interface units 112 may be configured to, at any time, receive the second user input indicating the presence of an escalator 302. For example, the user interface 112 may include a touch screen with various options (e.g., activate scrubbing pad for a floor cleaning robot) including a “map escalator” option, or similar verbiage. The user may indicate the location of the escalator 302 relative to the robot 102 via indicating the location of the escalator 302 on the computer-readable map, wherein the computer-readable map may be displayed on the user interface 112. In some embodiments, the operator may drive the robot 102 to the entrance of the escalator 302 and, subsequently, provide the second user input, wherein the controller 118 automatically assigns a region in front of the robot 102 as comprising an escalator.

To illustrate block 1108 further, FIG. 11B(i-ii) illustrates two exemplary non-limiting embodiments of the second user input. FIG. 11B(i-ii) both illustrate an exemplary user interface 1110 of user interface units 112 which display the most up-to-date computer-readable map produced by the robot 102 during the training in block 1106.

First, in FIG. 11B(i), the robot 102 is being driven along a route 1114 by the user. The location of the robot 102 in the environment is denoted by the location of footprint 1112 on the map. Various objects 1116 are shown, the objects 1116 being sensed by sensor units 114 of the robot 102. While training, the user interface 1110 may display various options for the user to utilize in training the robot 102. For example, robot 102 may include a floor cleaning robot, wherein interface 1110 may include an “activate scrubber” button or other task-specific features. The user interface may further include a “complete training” button and an “escalator present” button 1118. One skilled in the art may appreciate that the “activate scrubber” button may be replaced with other actuatable features for non-floor cleaning robots 102. Similarly, the interface 1110 is not intended to be limited to displaying only these three options and the layout/design is purely exemplary and non-limiting.

During the navigation of the route 1114, the user may provide the second user input (block 1108) to the interface 1110 by selecting the option “escalator present” 1118. In doing so, the user may, subsequently, provide inputs to the interface 1110 to indicate various points 1120. These points 1120 may correspond to boundaries of a “no-go zone” 1122 or region which, under no circumstances, is the robot 102 to navigate within the no-go zone 1122. For example, the user may tap a touch screen monitor to provide the points 1120. The no-go zone region 1122 may include the region defined by the points 1120. In some instances, the points 1120 may be independently dragged and moved to better define the area of the escalator by the operator.

FIG. 11B(ii) illustrates a different response to the user selecting the option 1118. In some embodiments, the computer-readable map may not be displayed to the operator and/or the interface 1110 may not facilitate the input of points 1120. In these embodiments, it may be required to navigate the robot 102 close to an escalator 302 (e.g., on top of the metallic plate 602) and, subsequently, select the option 1118 to cause the controller 118 to map the location of the escalator 302. Accordingly, in response to the user selecting the option 1118, the controller 118 may automatically place a no-go zone 1122 in front of the robot 102. In some embodiments, the no-go zone 1122 may encompass the current location of the robot 102, as well as an added safety precaution (i.e., by overestimating the size of the escalator 302).

According to at least one non-limiting exemplary embodiment, beacons may be affixed to escalator entrances to communicate to nearby robots 102 that an escalator 302 is present. These beacons may comprise of radio frequency beacons (e.g., RFID), auditory beacons (e.g., inside or outside of human audible range), visual beacons (e.g., lights; quick response codes, barcodes, or other computer-readable codes), magnetic beacons, infrared light beacons, and/or other stationary devices configured to communicate with communications units 116 of the robot 102 or be easily detectable by sensor units 114. Such beacons may be placed proximate to both entrances of an escalator or moving walkway. A controller 118 of a robot 102, upon detecting the presence of a beacon, may be alerted to the presence of an escalator 302 and, subsequently, avoid the area. In some instances, the robot 102 may stop based on its level of delocalization, or certainty of its position in its environment using processes discussed in FIG. 9-10 above, wherein detecting a beacon indicates a strong escalator detection.

The following figures are process flow diagrams illustrating the various independent methods of escalator detection of this disclosure. It is appreciated that, unless otherwise specified, the steps of the process flow diagrams are effectuated via a controller 118 executing computer-readable instructions from a non-transitory computer-readable memory 120. Methods 700, 1200, 1300, and 1400 each include an “escalator detection” block, wherein the controller 118 may either actuate away from or stop to avoid the detected escalator, and/or move to another method 700, 1200, 1300, or 1400 to verify its prediction. The methods 700, 1200, 1300, and 1400, as well as others of this disclosure, may be utilized either alone, or in conjunction; however, higher computational methods preferably should be utilized while the robot 102 is stopped.

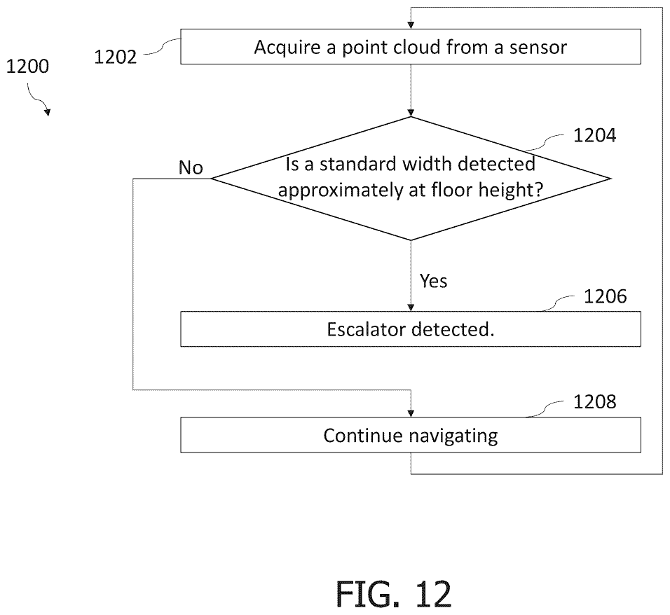

FIG. 12 is a process flow diagram illustrating a method 1200 for a controller 118 of a robot 102 to utilize LiDAR scans and/or depth images to detect an escalator, according to an exemplary embodiment. The method 1200 is shown in part and described above in FIG. 3B. For clarity, a floor includes a flat plane upon which a robot 102 navigates and will be defined as the z=0 plane.

Block 1200 includes the controller 118 acquiring a point cloud from a sensor 202. The point cloud may be two dimensional (depth, angle), such as from a planar LiDAR, or three dimensional (x, y, depth), such as a depth image from a depth camera. The field of view of the point cloud must, at least in part, encompass a floor in an object free environment.

Block 1204 includes the controller 118 determining if a standard width is detected at approximately floor height (z=0). As mentioned above, a standard width comprises a 24-, 32, or 40-inch width 322, or other pre-programmed value for non-standardized escalators/walkways with a margin of error for sensor noise. Steps of escalators are fixed in width 322, therefore searching for ‘corridors’ of these standard widths could indicate such ‘corridors’ are escalators. The controller 118 may consider points which are at or above floor height, up to approximately the height of balustrades 328 (e.g., 8 inches). If the point cloud acquired in block 1202 senses an escalator 302 entrance, there should exist a plurality of points on both balustrades 328 separated by the standard width.

If the controller 118 detects within the point cloud a standard width at or slightly above the z=0 floor, the controller 118 moves to block 1206.
controller 118 fails to detect a standard width at or slightly above the z=0 floor within the point cloud, the controller 118 moves to block 1208 and continues navigating and/or performing its tasks.

Block 1206 includes the controller 118 determining an escalator is present, or, at the very least, highly likely one is present. In some instances, the robot 102 may stop or slow substantially to avoid the escalator 302. In some instances, the controller 118 may plan a path away from the escalator 302, although in some instances such collision-free path solution may not exist. In some instances, such as when no collision free path exists, the controller 118 may request operator assistance. In some instances, the controller 118 may stop the robot 102 and perform other methods 700, 1300, 1400, and others disclosed herein to verify its detection of an escalator.

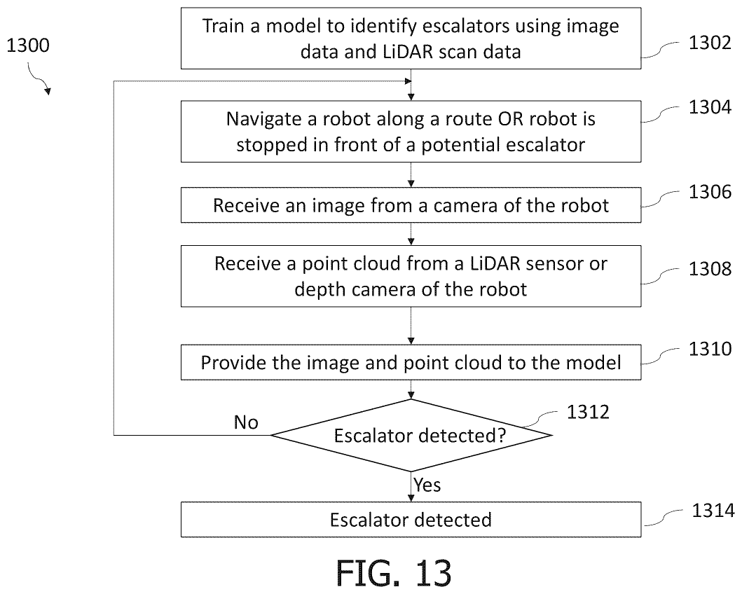

FIG. 13 is a process flow diagram illustrating a method 1300 for a controller 118 to identify escalators using, at least in part, imagery, according to an exemplary embodiment.

Block 1302 includes training of a model to identify escalators using image data and LiDAR scan data. The training or building of the model may be performed by an operator providing libraries of images 506 and libraries of LiDAR scans 514 depicting escalators, wherein the model builds upon similar patterns within the images and lidar scan libraries. Such patterns may be utilized to, given a new input image, draw similarities to the depicted escalators such that, upon reaching threshold similarity, the model may predict if an escalator is depicted in and image and LiDAR scan. In some embodiments, the model may comprise a (convolutional) neural network configured to receive pairs of LiDAR scans and images of an escalator to generate a predictive output indicating the presence, or lack thereof, of an escalator. The training of the model may be performed on a separate computing device than the robot 102, such as a desktop computer, wherein the completed model may be communicated and downloaded by the controller 118 of the robot 102. Preferably such model would be constructed and installed onto the robot 102 prior to the robot 102 navigating a route or performing a task.

Block 1304 includes the controller 118 navigating a robot along a route or the robot 102 is currently stopped due to detection of a potential escalator. Stated differently, the following steps may be utilized as an independent method of escalator detection, or as a secondary verification of, e.g., methods 700 and 1200 above.

Block 1306 includes the controller 118 receiving an image from a camera 502 of the robot 102. The image may be a colorized, RGB image, greyscale image, heat image, or other modality, provided the library used to train the model in block 1302 is of the same modality.

Block 1308 includes the controller 118 receiving a LiDAR scan or depth image sensor 202 of the robot 102. Similar to block 1306, the modality of the library 514 used to train the model in block 1302 should match the modality of the sensor 202. The point cloud should be received roughly contemporaneously (e.g., within a few milliseconds) as the image in block 1306.

Block 1310 includes the controller 118 providing both the image and the point cloud to the trained model. The trained model may, given the input image and point cloud, calculate an output based on a plurality of weights of nodes if the model is a neural network. The trained model may, alternatively, search for similar features in the incident image and point cloud to the libraries 506, 514 using sliding window filters or other filtering methods. The trained model should provide a prediction as output, the prediction indicates if an escalator is present or not. In some embodiments, the prediction may also carry an associated confidence value.

Block 1312 includes the controller 118 determining if an escalator is detected based on the output of the model. Various threshold methods may be utilized to determine if an escalator is present given the prediction and associated confidence. For instance, a prediction that an escalator is present with high confidence would indicate an escalator is very likely present; however, a low-confidence prediction that an escalator is present may not meet a threshold for detection. In instances with low confidence, the controller 118 may continue to acquire new images and provide them to the model until the model is able to confidently (i.e., above a threshold) provide an output. The exact numeric value for the threshold confidence needed to be a positive or negative escalator detection may be determined by the specific model used. However, it is preferred that for negative detection, the threshold be very high before the robot 102 continues navigating as false negatives pose a substantial risk to safety whereas false positives primarily pose a risk to operational performance.

According to at least one non-limiting exemplary embodiment, the model may be further configured to identify specific points 204 and/or pixels of images which correspond to an escalator. For example, bounding boxes or sematic segmentation methods.

Upon the controller 118, using the trained model, detecting an escalator 302, the controller 118 moves to block 1314.
the controller 118, using the trained model, not detecting an escalator 302, the controller 118 returns to block 1304 and continues navigating.

Block 1314 include the controller 118 detecting an escalator. As discussed above with reference to block 1206 of FIG. 12, the controller 118 may stop the robot 102, slow the robot 102, hail for human assistance, attempt to reroute, or further utilize other methods for escalator detection disclosed herein to verify its prediction.

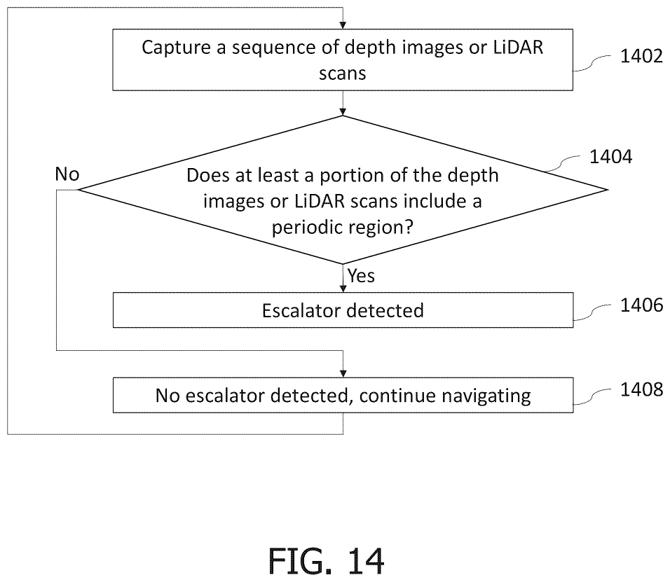

FIG. 14 is a process flow diagram illustrating a method 1400 for a controller 118 of a robot 102 to detect and/or verify the presence of an escalator, according to an exemplary embodiment. Unlike other methods of this disclosure, method 1400 is configured to detect specifically escalators from the top of their staircase. However, one skilled in the art may appreciate the reduced computational complexity to detect such hazard as compared to, e.g., methods 1200, 1300.

According to at least one non-limiting exemplary embodiment, method 1300 may only include one sensor modality. For instance, RGB images. The model in block 1302 may be trained to only utilize RGB images and detect escalators therein, wherein block 1308 may be skipped. Alternatively, only point cloud data may be utilized in a similar manner. It is appreciated, however, that use of multiple independent sensors of different modalities may improve the precision of the trained escalator detection model at the cost of increased computational bandwidth needed to train and run the model.

Block 1402 includes the controller 118 capturing a sequence of depth images or LiDAR scans. The sequence of depth images and/or LiDAR scans includes, at least in part, a section of floor ahead of the robot 102. Preferably the section of floor is beyond the maximum stopping distance of the robot 102 such that, in the even an object/cliff is ahead of the robot 102, the robot 102 is able to stop before encountering the hazard. The sequence of depth images or LiDAR scans may form a ‘point cloud video’ of the environment and capture temporal changes.

Block 1404 includes the controller 118 determining if at least a portion of the images or LiDAR scans include a periodic region, such as the region 414 in FIG. 4A(ii)-B(i-ii). The periodic region for depth images comprises of a two-dimensional region of pixels which, for a stationary robot 102, comprise periodic distance measurements, such as the approximate saw tooth function described above in FIG. 4B(i-ii). Such periodic region may be indicative of a first moving step appearing and falling below a horizon or under a stationary portion 310. Very few typical objects in most environments would exhibit such a periodic distance aside from escalators.

For planar LiDAR scans, it is highly preferred that the planar LiDAR be incident upon an otherwise flat floor at a distance beyond the stopping distance of the robot 102. The minimum distance the LiDAR is incident upon the floor, measured from the front of the robot 102, should be the maximum stopping distance, plus the length of a moving step of an escalator. This is preferred as use of a planar LiDAR as shown in FIG. 4B(i-ii), wherein the measurement plane would be into/out of the page parallel to vector 408, may cause the robot 102 to not detect a cliff until the first moving step has reached a maximum distance 402. This scenario may cause the robot 102 to navigate closest to the moving steps and only stop (i.e., sense a cliff) once the first moving step has reached a maximum distance 402, wherein upon the first moving step moving out of the path of vector 408 the robot 102 detects a cliff and begins to stop. If the planar LiDAR is incident upon a flat floor at a distance equal to the maximum stopping distance of the robot 102 plus the maximum distance 402, the moment the first moving step 408 moves from the path of vector 408 and the cliff is sensed, the distance between the robot 102 and first moving step should be exactly its maximum stopping distance. Thus, it is preferred, for safety, to have the location where the LiDAR is incident upon the floor be beyond this distance to account for latency, noise, and imperfect calibration.

In some instances, once the robot 102 detects a cliff due to the first moving step moving out of the path of vector 408, the robot should stop and observe a roughly periodic distance signal as the next moving step comes into view provided the stopping distance is short. However, in some instances, such as the scenario above where the robot 102 does not sense a cliff until the first moving step has reached a maximum distance 402, the robot 102 takes non-zero distance to fully stop, causing the first moving step to be between vector 408 and the robot 102 body, wherein no periodic signal is sensed.

Upon the controller 118 detecting a periodic region within the depth imagery or LiDAR scan, the controller 118 moves to block 1406.

Upon the controller 118 failing to detect a periodic region within the depth imagery or LiDAR scan, the controller 118 moves to block 1408 and continues navigating.

Block 1406 includes the controller 118 determining an escalator is present. As discussed above in reference to block 1206 of FIG. 12 and block 1314 of FIG. 13, the controller 118 may: stop the robot 102; hail for human assistance; reroute away from the escalator if possible; and/or utilize other methods 700, 1200, 1300 and others of this disclosure to verify its detection.

Advantageously, the escalator detection methods disclosed herein utilize independent measurements to independently detect an escalator, wherein use of two or more of these methods in conjunction may be readily utilized to verify a prediction from either method. Additionally, many of the methods work in conjunction with typical sensors utilized by robots 102 to detect cliffs and walls.

According to at least one non-limiting exemplary embodiment, upon detecting and, if so chosen, confirming a presence of an escalator the controller 118 may be tasked with placing the escalator on a computer-readable map it uses to navigate in its environment. Method 1100 provides the simplest way to map an escalator; however, a human input is required which may not be desirable for every circumstance. Especially in environments with many robots 102 and many escalators. Methods 1200, 1300, and 1400 may be performed, at least in part, using point cloud data. Point clouds include points at known (x, y, z) for all three reference frames discussed in FIG. 2B: (i) world frame centered about world origin 220, (ii) robot frame centered about robot origin 216, and (iii) local sensor frame centered about the sensor origin 210. The (x, y, z) location in any reference frame may be translated to another reference frame via known transforms 214 (world/robot) and 218 (robot/sensor). Thus, if points of the point clouds can be identified as corresponding to an escalator, the area of the escalator may be easily mapped.

For example, method 1200 includes detecting if a standard width 322 is present. Such standard width 322 may be measured between various pairs of points 204. If those points 204 comprise a standard width, the points 204 may be considered “escalator” points 204 and their corresponding (x, y, z) locations may be marked as no-go zones. In this embodiment, it may be preferred that, for each point on opposing sides of the standard width, the escalator area be larger than the point themselves as to encompass the balustrades and handrails. For instance, each point which defines the standard width may define a 3-foot radius no-go zone.

As another example, in method 1300, the trained model may identify particularly which points are escalator and which are not escalator, wherein translating to area on a computer-readable map becomes trivial. If method 1300 is executed using only images and no depth/point cloud data, differential motion estimations may be utilized to extract depth information from the scene.

It will be recognized that, while certain aspects of the disclosure are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and affected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A robotic system, comprising:
a memory comprising computer readable instructions stored thereon; and
at least one controller configured to execute the computer readable instructions to:
navigate the robotic system along a route;
detect, using data from at least one sensor unit, an escalator;
modify the route to cause the robotic system to stop upon detection of the escalator; and
navigate the robotic system away from the escalator.

2. The robotic system of claim 1, wherein the controller is further configured to execute the computer readable instructions to:
identify a location of the escalator on a computer readable map as a no-go zone, the no-go zone corresponds to location the robotic system avoids navigating thereto.

3. The robotic system of claim 2, wherein,
the at least one sensor unit includes units for localizing the robotic system; and
the no-go zone corresponding to placement of the escalator on the computer readable map by an operator providing input to a user interface of the robotic system.

4. The robotic system of claim 3, wherein,
the route was previously learned by an operator driving, pushing, pulling, leading, or otherwise moving the robotic system along the route.

5. The robotic system of claim 4, wherein,
the user interface displays the computer readable map to the operator; and
the user input corresponds to the operator defining a region which encompasses the escalator on the computer readable map during teaching of the route.

6. The robotic system of claim 1, wherein,
the at least one sensor includes a gyroscope, the data from the gyroscope indicates the robotic system is vibrating due to navigating over a grated metallic plate of an escalator.

7. The robotic system of claim 1, wherein,
the at least one sensor includes an image sensor configured to capture a plurality of images; and
the at least one controller is further configured to execute the computer readable instructions to detect optical flow within the plurality of images, the optical flow being substantially upwards or downwards corresponds to moving steps of an escalator.

8. The robotic system of claim 7, wherein,
the optical flow is detected using a vertical strip of pixels within the plurality of images.

9. The robotic system of claim 1, wherein,
the at least one sensor includes an image sensor, the data from the image sensor includes a plurality of images; and
the at least one controller is further configured to execute the computer readable instructions to,
embodying a model, the model is configured to compare the plurality of images with images from a library of escalator images, and
detect the escalator based upon one or more images of the plurality of images exceeding a threshold similarity with images from the library.

10. The robotic system of claim 9, wherein the at least one controller is further configured to execute the computer readable instructions to:
receive a scan from a LiDAR sensor; and
provide the depth data to the model, wherein the model is further configured to compare the plurality of images and the depth data from the LiDAR to the library of images and a library of depth data, the library of depth data includes at least in part depth data of one or more escalators,
wherein, the model is further configured to detect similarities in contemporaneously captured depth data from the LiDAR sensor and images from the image sensor with pairs of images and depth data of escalators within the library of images and library of depth data.

11. The robotic system of claim 1, wherein the at least one controller is further configured to execute the computer readable instructions to:
determine if the robotic system is delocalized based at least in part on scan matching; and
stop the robotic system if at least one of an escalator being detected or the robotic system becoming delocalized.

12. A method of navigating a robot, comprising a controller of the robot:
navigating the robot through a route;
detecting, using data from at least one sensor unit, an escalator; and
stopping or slowing the robot; and
navigate away from the escalator if the detection is detected, or seek human assistance if a collision free path for the robot is not available.

13. The method of claim 12, wherein,
the detecting of the escalator further comprised detecting, within a LiDAR scan, a standard width ahead of the robot at approximately a height of a floor upon which the robot navigates.

14. The method of claim 13, wherein,
the standard width comprises approximately 24 inches, 32 inches, 40 inches, or a pre-programmed value corresponding to a width of one or more escalators or moving walkways within an environment of the robot.

15. The method of claim 12, wherein,
the detecting of the escalator further comprises,
executing, via a controller, a pre-configured model, the pre-configured model being configured to receive as input one or both of a LiDAR scan and an image captured by either a single depth camera or a LiDAR sensor and an imaging sensor contemporaneously, and
receiving, via the controller, as output from the pre-configured model an indication of the escalator presence within one or both of the LiDAR scan and the image.

16. The method of claim 15, wherein,
the pre-configured model is further configured to identify at least one of points of the LiDAR scan and pixels of the input image represent the escalator, wherein locations of the points or pixels are transferred onto a computer readable map as a no-go zone, the no-go zone comprising a region within which navigation is impermissible by the robot.

17. The method of claim 12, wherein,
the detecting of the escalator further comprises,
capturing, via a controller, a sequence of scans from a LiDAR sensor;
detecting, via the controller, a cliff ahead of traveling of the robot;
stopping, via the controller, of the robot in response to the detection of the cliff; and
detecting, while stopped, a region within the sequence of scans from the LiDAR sensor a region comprising a periodic distance measurement, the region corresponding to moving steps of an escalator.

18. The method of claim 17, wherein,
the LiDAR sensor is configured to sense an area in a forward direction of travel of the robot, wherein the area is at a distance greater than or equal to the maximum stopping distance of the robot plus a width of an escalator stair step.

19. The method of claim 18, wherein,
the pre-configured model is further configured to identify at least one of points of the LiDAR scan and pixels of the input image represent the escalator;
transferring the locations of the points or pixels onto a computer readable map as a no-go zone, the no-go zone comprising a region within which navigation is impermissible by the robot;
the LiDAR sensor is configured to sense an area in a forward direction of travel of the robot, wherein the area is at a distance greater than or equal to the maximum stopping distance of the robot plus a width of an escalator stair step.

20. A robot, comprising:
a non-transitory computer readable storage medium having a plurality of computer readable instructions stored thereon; and
a controller configured to execute the computer readable instructions to:
navigate the robot along a route;
detect an escalator, the detection of the escalator is performed by one or more of:
(i) detecting, within a LiDAR scan, a standard width ahead of the robot at approximately a height of a floor upon which the robot navigates, wherein the standard width comprises approximately 24 inches, 32 inches, 40 inches, or a pre-programmed value corresponding to a width of one or more escalators or moving walkways within an environment of the robot; or
(ii) executing a pre-configured model, the pre-configured model being configured to receive as input one or both of a LiDAR scan and an image captured by either a single depth camera or a LiDAR sensor and an imaging sensor contemporaneously, and receiving as output from the pre-configured model an indication of escalator presence within one or both of the LiDAR scan and the image; or
(iii) capturing a sequence of scans from a LiDAR sensor,
detecting a cliff ahead of the robot,
stopping the robot in response to the cliff, and
detecting the escalator by, while stopped, detecting a region within the sequence of scans from the LiDAR sensor a region comprising a periodic distance measurement, the region corresponding to moving steps of an escalator; or
(iv) detect, via a gyroscope, the robot vibrating via detecting a sudden increase in noise or rapid small rotations from the gyroscope,
stopping the robot, and
detecting a metallic plate in front of an escalator upon the vibrations ceasing while the robot is idle; and
attempt to navigate away from the escalator if the detection is detected, or hail for human assistance if a collision free path is not available.
